(19) United States
(12) Patent Application Publication
(10) Pub. No.: US 2010/0218305 A1
(43) Pub. Date: Sep. 2, 2010

(54) Negative pressure protection system

(76) Inventors: Richard Scott Weston, Carlsbad, CA (US); Eric W. Newgent, Baraboo, WI (US); Farhad Bybordi, Pompano Beach, FL (US)

Correspondence Address: PROCOPIO, CORY, HARGREAVES & SAVITCH LLP, 525 B STREET, SUITE 2200, SAN DIEGO, CA, 92101, US

(21) Appl. No.: 11/491,578

(22) Filed: Jul. 24, 2006

Related U.S. Application Data
(60) Provisional application No. 60/703,495, filed on Jul. 26, 2005.

(51) Int. Cl. A41D 13/002; A62B 17/00

(52) U.S. Cl. 2/457

(57) ABSTRACT

A negative pressure protective system is provided for protection of persons (including animals) from harmful environments, such as environments containing hazardous materials. In one aspect, the system provides for protection of extremities, such as hands, wrists, feet and ankles, by enclosing the extremities with an extremity enclosure that is maintained at negative pressure or a vacuum. The system may also provide for an extremity liner and sensors to monitor conditions in the enclosure. The enclosure may also be used in conjunction with environmentally controlled enclosures, such as may be used in laboratories. In other aspects, the system provides for a partial body casing that encloses the torso and a portion of the neck, arms and legs. The partial body casing may be used with head, hand or foot casings that are also under negative pressure. In still other aspects, the system provides for a whole body casing, which is maintained at negative pressure and encloses the entire body, except for the head and a portion of the neck.

### CROSS REFERENCES TO OTHER APPLICATIONS

This application claims the benefit of U.S. provisional application No. 60/703,495, filed on Jul. 26, 2005. The full disclosure of this provisional application is incorporated herein by reference.

### BACKGROUND

The present invention generally relates to protection of persons from harmful environments. More specifically, the present invention relates to improved apparatus and methods for providing such protection by means of applying negative pressure to various gas and liquid impermeable enclosures so that the portion of the body enclosed by the enclosures is subject to negative pressure. In this context, “negative pressure” means pressure less than the ambient pressure of the environment in which the apparatus is positioned and operating. In addition, “persons” and “body” refer to both humans and animals.

The need to protect persons from hazardous environments has existed for some time. For example, it has long been necessary to protect firefighters and others from smoke in burning buildings. As another example, persons called upon to clean up spills of hazardous materials also need protection so that they do not come into direct contact with such materials. The need for this type of protection has increased with the war on terrorism. Now, for example, law enforcement personnel are faced with the possibility of operating in environments that may have been contaminated with radioactive or bio-hazardous materials (such as anthrax and smallpox) or both simultaneously. It may also be necessary for bomb-sniffing dogs to operate in these types of contaminated areas. In addition, the operations conducted in these hazardous environments may require a high degree of dexterity, such as operating weaponry or defusing explosive devices.

There exist in the relevant art means to provide protection for persons (both human and animal) that are operating in adverse environmental conditions. For example, there are suits that may be used to protect firemen and law enforcement personnel against hazardous materials that may be present within a building. In addition, there are suits that may be used by remediation workers when it is necessary to enter buildings and other areas where hazardous materials are present. These suits, however, generally suffer from several disadvantages. Among them is the fact that they are often heavy and bulky. The material from which the suit is constructed often protrudes away from the body of the person wearing it in a manner so that motion is inhibited. The person may not be able to rapidly retreat from or move to confront a threat against them. Further, such suits often have bulky gloves that are a part of the suit. Because of the thickness and rigidity of the gloves, it is typically difficult for the person to move his or her fingers while wearing the gloves. As a result, the person may not be able to perform the required tasks, such as the weapons operation and explosive device defusing referred to above. For example, the fingers may not have the required dexterity. The gloves may also prevent the person from having an adequate sense of touch. The same types of problems are also often present in foot coverings that are a part of such suits. For example, the boots are often so bulky and cumbersome that they do not allow for rapid movement. In addition, they may not allow the wearer to have a “feel” for the stability of the surface on which he or she is walking. Yet another disadvantage of such suits is that they do not typically have a ready means to detect and provide notice to the wearer (or others monitoring the wearer's activities) of a leak in the suit. For example, a tear in the suit may go unnoticed until it is too late—until the person wearing the suit has been adversely affected by the hazardous materials present in the environment. Still another disadvantage is that these types of suits may also be expensive to manufacture and maintain.

There are also other applications in which there is a need to protect a person from a hazardous environment. These applications include ventilated hood enclosures, such as are 10 often found in laboratories and other research facilities. In such cases, the person performing operations within the hood enclosure may insert his or her hands into glove-type devices that protrude into and are a part of the hood enclosure. The person then manipulates objects within the hood enclosure by moving the gloves. The same problems described above are also often present in these applications. For example, the gloves may not provide adequate dexterity for the operator and the thickness of the gloves may prevent the operator from having an adequate sense of touch in manipulating the objects within the hood enclosure. In addition, the gloves may not have an adequate means to detect and provide notice of any leak to the operator or others.

### SUMMARY

The present invention is directed to a negative pressure protection system that overcomes the disadvantages of the existing protective means described above. As described in greater detail below, the present invention has many advantages over existing protection means when used for its intended purpose, as well as novel features that result in a new negative pressure protection system that is not anticipated, rendered obvious, suggested, or even implied by any of the prior art means, either alone or in any combination thereof.

In accordance with the present invention, a negative pressure protection system is provided for protecting all or a portion of a body against a hazardous ambient environment. In one aspect of a first version of the present invention, an apparatus is provided for protecting an extremital portion of a body against hazardous materials in such environments. In this aspect, the apparatus comprises an extremity enclosure having an enclosure opening, extremity enclosure sealing means (which are described in more detail below), and negative pressure supply means (which are also described in more detail below). The extremity enclosure has an enclosure opening, is fluid-impermeable, is not adversely affected by the hazardous materials, and is of a size and shape adapted to be placed over and enclose the extremital portion of the body. The extremity enclosure sealing means is used to seal the portion of the extremity enclosure that is adjacent to the enclosure opening to the adjacent extremital portion of the body, so that negative pressure may be maintained in the volume surrounding the extremital portion of the body within the extremity enclosure. The negative pressure supply means operably connects a negative pressure supply source to the extremity enclosure, so that negative pressure may be supplied to the volume within the extremity enclosure. In some embodiments, the extremity enclosure may further comprise at least one sensor member, a control unit, and electronic communication means. The control unit may be further comprised of the negative pressure supply source, and the electronic communication means operably connects the control unit to the at least one sensor member. In other embodiments, the control unit may be further comprised of functions involving the global positioning system (GPS), navigation or homing, or Command Control Communication (C3).

In yet other embodiments, the apparatus may further comprise the negative pressure supply source, which is a portable vacuum pump. In still other embodiments, a portion of the extremity enclosure may be shaped approximately as a hand and wrist or approximately as a foot and ankle. In other embodiments, the apparatus may be further comprised of an extremity liner having a liner opening and extremity enclosure sealing means (which are described in more detail below). The extremity liner is of a size and shape adapted to be placed over and enclose the extremital portion of the body and is positioned between the extremital portion of the body and the extremity enclosure. The extremity enclosure sealing means is also used to seal the portion of the extremity liner that is adjacent to the liner opening to the adjacent extremital portion of the body or the extremity enclosure. In yet other embodiments, the apparatus may further comprise negative pressure distribution means, which are operably connected to the negative pressure supply means and distribute negative pressure in the volume within the extremity enclosure. In still other embodiments, the apparatus may further comprise a lumen system, which provides fluids to and removes fluids from the volume within the extremity enclosure. In other embodiments, the apparatus may further comprise means to assist in putting on and taking off the extremity enclosure. In still other embodiments, the negative pressure maintained in the volume within the extremity enclosure is in the range between 40 mm Hg and 150 mm Hg.

In a second aspect of the present invention, the apparatus may further comprise an environmental enclosure, a portal member, an extremity enclosure having an enclosure opening, portal sealing means to operably seal the portal member to the extremity enclosure (described in more detail below), extremity enclosure sealing means to seal the enclosure opening (described in more detail below), and negative pressure supply means (described in more detail below). The environmental enclosure has a boundary wall. In addition, the interior volume of the environmental enclosure is isolated from the surrounding environment so that the hazardous materials do not come into contact with the surrounding environment. The portal member is positioned within a portal in the boundary wall. The extremity enclosure is fluid-impermeable, is not adversely affected by the hazardous materials, and is of a size and shape adapted to be placed over and enclose an extremital portion of the body of a user that may be positioned within the environmental enclosure. The portal sealing means (described in more detail below) operably seal the portal member to the extremity enclosure so that the volume within the extremity enclosure is not in fluid communication with the volume inside the environmental enclosure. The extremity enclosure sealing means (described in more detail below) seal the enclosure opening so that negative pressure may be maintained in the volume surrounding the extremital portion of the body within the extremity enclosure. The negative pressure supply means (described in more detail below) operably connect a negative pressure supply source to the extremity enclosure, so that negative pressure may be supplied to the volume within the extremity enclosure by the negative pressure supply source. In some embodiments, the apparatus includes at least one sensor member positioned within or on the extremity enclosure and electronic communication means for operably connecting the at least one sensor member to a control unit. In other embodiments, the apparatus further comprises the control unit or the negative pressure supply source or both. A portion of the extremity enclosure may be shaped approximately as a hand and wrist. The apparatus may also be further comprised of an extremity liner having a liner opening. The extremity liner is of a size and shape adapted to be placed over and enclose the extremital portion of the body and is positioned between the extremital portion of the body and the extremity enclosure. The apparatus may also further comprise negative pressure distribution means for distributing negative pressure in the volume within the extremity enclosure. In such embodiments, the negative pressure distribution means are operably connected to the negative pressure supply means. Further, the apparatus may further comprise a lumen system for providing fluids to and removing fluids from the volume within the extremity enclosure. In other embodiments, the negative pressure maintained in the volume within the extremity enclosure is in the range between 40 mm Hg and 150 mm Hg.

In a third aspect of the first version of the present invention, an apparatus is provided for protecting a portion of a body against hazardous environments. In this aspect, the apparatus is comprised of a partial body enclosure, a seal (which is described in more detail below), and negative pressure distribution means (which are also described in more detail below). The partial body enclosure is fluid-impermeable and is not adversely affected by the hazardous materials in the environment. In addition, the partial body enclosure is of a size and shape adapted to be 10 placed over and enclose the torso and portions of the neck, arms and legs of the body. It also has a body enclosure opening at each end of the neck, arm and leg portions of the partial body enclosure. The seal operably seals the body enclosure openings at the ends of the neck, arm and leg portions of the partial body enclosure, so that negative pressure may be maintained in the volume within the partial body enclosure. The negative pressure distribution means (which are also described in more detail below) operably connect a negative pressure supply source to the partial body enclosure and distribute negative pressure in the volume within the partial body enclosure. In some embodiments, the partial body enclosure may further comprise at least one sensor member, a control unit, and electronic communication means. The control unit may be further comprised of the negative pressure supply source, and the electronic communication 20 means operably connects the control unit to the at least one sensor member. In other embodiments, the apparatus may further comprise the negative pressure supply source, which is a portable vacuum pump. In yet other embodiments, the apparatus may further comprise a partial body liner. The partial body liner is of a size and shape adapted to be placed over and enclose the torso and a portion of the neck, arms and legs of the body. It is positioned between the torso, neck, arms and legs of the body and the partial body enclosure, and has a liner opening at each end of the neck, arm and leg portions of the partial body liner. In still other embodiments, the apparatus may further comprise at least one extremity casing. The at least one extremity casing further comprises an extremity enclosure having an extremity opening and extremity negative pressure supply means (which are described in more detail below). The extremity enclosure is fluid-impermeable and is not adversely affected by the hazardous materials. In addition, it is of a size and shape adapted to be placed over and enclose an extremital portion of the body that is not enclosed by the partial body enclosure. Further, it is adapted to have the portion of the extremity enclosure adjacent to the extremity opening positioned adjacent to the portion of the partial body enclosure that is adjacent to a body enclosure opening at the end of an arm or leg portion of the partial body enclosure. The extremity negative pressure supply means operably connects the negative pressure supply source to the extremity enclosure, so that negative pressure may be supplied to the volume within the extremity enclosure. In these embodiments, the seal at the body enclosure opening adjacent to the at least one extremity casing is comprised of body/extremity enclosure sealing means, which operably seal the extremity enclosure of the at least one extremity casing to the partial body enclosure, so that negative pressure may be maintained in the volume surrounding the portion of the body within the volume of the partial body enclosure and the extremity enclosure. In other embodiments, the apparatus may be further comprised of at least one extremity liner having a liner opening and extremity enclosure sealing means (which are described in more detail below). The at least one extremity liner is of a size and shape adapted to be placed over and enclose the extremital portion of the body and is positioned between the extremital portion of the body and the extremity enclosure of the at least one extremity casing. In yet other embodiments, the at least one extremity enclosure may further comprise at least one sensor member, a control unit, and electronic communication means. The control unit may be further comprised of the negative pressure supply source, and the electronic communication means operably connect the control unit to the at least one sensor member. In still other embodiments, the apparatus may be further comprised of a head casing and body/head enclosure sealing means (which are described in more detail below). The head casing further comprises a head enclosure having an enclosure opening. The head enclosure is fluid-impermeable and is not adversely affected by the hazardous materials. The head enclosure is also of a size and shape adapted to be placed over and enclose the head and neck portions of the body that are not enclosed by the partial body enclosure. It is also adapted to have the portion surrounding the enclosure opening of the head enclosure positioned adjacent to the portion of the partial body enclosure that surrounds the opening at the end of the neck portion of the partial body enclosure. The body/head enclosure sealing means operably seals the portion of the head enclosure that is positioned adjacent to the partial body enclosure to the partial body enclosure, so that the volume within the head enclosure is not in fluid communication with the ambient environment or the volume within the partial body enclosure. In other embodiments, the apparatus may further comprise means to assist in putting on and taking off the partial body casing. In still other embodiments, the negative pressure maintained in the volume within the partial body enclosure may be in the range between 40 mm Hg and 150 mm Hg.

In a fourth aspect of the first version of the present invention, an apparatus is provided for protecting a portion of a body against hazardous environments. In this aspect, the apparatus is comprised of a partial body casing, two hand casings, two foot casings, and body/extremity enclosure sealing means (which are described in more detail below). The partial body casing further comprises a partial body enclosure, extremity enclosure sealing means (which are described in more detail below), and negative pressure distribution means (which are also described in more detail below). The partial body enclosure may generally have any of the structure, features, characteristics and operation as the partial body enclosure described above with respect to the third aspect of the first version of the present invention. The extremity enclosure sealing means operably seals the portion of the partial body enclosure that is adjacent to the enclosure opening at the end of the neck portion of the partial body enclosure, so that negative pressure may be maintained in the volume within the partial body enclosure. The negative pressure distribution means operably connects a negative pressure supply source to the partial body enclosure and distributes negative pressure in the volume within the partial body enclosure. Each of the two hand casings further comprises a hand enclosure having a portion in the approximate shape of a hand and wrist and hand casing negative pressure supply means (which are described in more detail below). The hand enclosure has a hand enclosure opening, is fluid-impermeable, and is not adversely affected by the hazardous materials. In addition, the hand enclosure is of a size and shape adapted to be placed over and enclose an arm, wrist and hand portion of the body that is not enclosed by the partial body enclosure, except that it has the portion surrounding the hand enclosure opening positioned adjacent to the portion of the partial body enclosure that surrounds the enclosure opening at the end of the arm portion of the partial body enclosure. The hand casing negative pressure supply means operably connects the negative pressure supply source to the hand enclosure, so that negative pressure may be supplied to the volume within the hand enclosure. Each of the two foot casings further comprises a foot enclosure having a portion in the approximate shape of a foot and ankle and foot casing negative pressure supply means (which are described in more detail below). The foot enclosure has a foot enclosure opening, is fluid-impermeable, and is not adversely affected by the hazardous materials. In addition, each foot enclosure is of a size and shape adapted to be placed over and enclose a foot, ankle and lower leg portion of the body that is not enclosed by the partial body enclosure, except that it has the portion surrounding the foot enclosure opening positioned adjacent to the portion of the partial body enclosure that surrounds the enclosure opening at the end of the leg portion of the partial body enclosure. The foot casing negative pressure supply means operably connects the negative pressure supply source to the foot enclosure, so that negative pressure may be supplied to the volume within the foot enclosure. The body/extremity enclosure sealing means operably seals the portions of each of the two hand enclosures and each of the two foot enclosures that are positioned adjacent to the partial body enclosure to the partial body enclosure, so that negative pressure may be maintained in the volume within the partial body enclosure. In some embodiments, the apparatus further comprises a partial body liner and extremity enclosure sealing means (which are described in more detail below). The partial body liner is of a size and shape adapted to be placed over and enclose the torso and a portion of the neck, arms and legs of the body, is disposed between the torso, neck, arms and legs of the body and the partial body enclosure, and has a liner opening at the ends of the neck, arm and leg portions of the partial body liner. The extremity enclosure sealing means operably seals the portions of the partial body liner that are adjacent to the liner openings at the neck, arm and leg portions of the partial body liner. In other embodiments, the apparatus may further comprise at least one hand liner having a hand liner opening and extremity enclosure sealing means (which are described in more detail below) to seal a portion of the at least one hand liner that is adjacent to the hand liner opening to the adjacent portion of the body or the partial body liner or both. A portion of the at least one hand liner is approximately in the shape of a hand and wrist and is of a size and shape adapted to be placed over and enclose the hand, wrist and lower arm portion of the body that is not enclosed by the partial body enclosure. The at least one hand liner is positioned between the portion of the body enclosed by the at least one hand liner and the hand enclosure. In yet other embodiments, the apparatus may further comprise at least one foot liner having a foot liner opening and extremity enclosure sealing means (which are described in more detail below) to seal a portion of the at least one foot liner that is adjacent to the foot liner opening to the adjacent portion of the body or the partial body liner or both. A portion of the at least one foot liner is approximately in the shape of a foot and ankle and is of a size and shape adapted to be placed over and enclose the foot, ankle and lower leg portion of the body that is not enclosed by the partial body enclosure. The at least one foot liner is positioned between the portion of the body enclosed by the at least one foot liner and the foot enclosure. In still other embodiments, the partial body casing further comprises at least one sensor member, and the apparatus further comprises a control unit and electronic communication means. The control unit may be further comprised of the negative pressure supply source, and the electronic communication means operably connect the control unit to the at least one sensor member. In yet other embodiments, any of the two hand casings or two foot casings may further comprise at least one hand sensor member or at least one foot sensor member, respectively, and the apparatus may also further comprise a control unit and electronic communication means. In these embodiments, the electronic communication means operably connect the control unit to the at least one hand sensor member or at least one foot sensor member, respectively. In other embodiments, the apparatus may further comprise the negative pressure supply source, which is a portable vacuum pump. In still other embodiments, the apparatus may further comprise means to assist in putting on and taking off the partial body casing. In yet other embodiments, the apparatus may further comprise a head casing and body/head enclosure sealing means (which are described in more detail below) to seal the portion of the head enclosure that is positioned adjacent to the partial body enclosure to the partial body enclosure, so that the volume within the head enclosure is not in fluid communication with the ambient environment or the volume within the partial body enclosure. The head casing further comprises a head enclosure having a head enclosure opening. The head enclosure is fluid-impermeable and is not adversely affected by the hazardous materials. It is also of a size and shape adapted to be placed over and enclose the head and neck portions of the body that are not enclosed by the partial body enclosure, and is adapted to have the portion surrounding the head enclosure opening of the head enclosure positioned adjacent to the portion of the partial body enclosure that surrounds the enclosure opening at the end of the neck portion of the partial body enclosure. In some of these embodiments, the apparatus may further comprise an air supply source and air supply source connection means to operably connect the air supply source to the head enclosure, so that a supply of breathable gas may be supplied to the volume within the head enclosure by the air supply source. In yet other embodiments, the negative pressure maintained in the volume within the apparatus is in the range between 40 mm Hg and 150 mm Hg.

In an aspect of a second version of the present invention, an apparatus is provided for protecting a portion of a body against hazardous environments. In this aspect, the apparatus is comprised of a whole body enclosure, extremity enclosure sealing means (which are described in more detail below), a negative pressure supply source, and negative pressure distribution means (which are also described in more detail below). The whole body enclosure is fluid-impermeable and is not adversely affected by the hazardous materials. It is of a size and shape adapted to be placed over and enclose a portion of the neck and all portions of the body below such portion of the neck, and has an enclosure opening at the end of the neck portion of the whole body enclosure. The extremity enclosure sealing means operably seals the portion of the whole body enclosure that is adjacent to the enclosure opening at the end of the neck portion of the whole body enclosure to the adjacent portion of the body, so that negative pressure may be maintained in the volume within the whole body enclosure. The negative pressure distribution means operably connect the negative pressure supply source to the whole body enclosure and distribute negative pressure in the volume within the whole body enclosure. In some embodiments, the apparatus may further comprise a whole body liner and extremity enclosure sealing means (described in more detail below) to operably seal the portion of the whole body liner that is adjacent to the liner opening at the neck of the whole body liner to the adjacent portions of the body. The whole body liner is of a size and shape adapted to be placed over and enclose a portion of the neck and all portions of the body below such portion of the neck, has a liner opening at the end of the neck portion of the whole body enclosure, and is positioned between the portion of the body enclosed by the whole body liner and the whole body enclosure. In other embodiments, the apparatus may further comprise means to assist in putting on and taking off the whole body liner or to assist in putting on and taking off the whole body enclosure. In still other embodiments, the apparatus may further comprise at least one sensor member, a control unit, and electronic communication means. The control unit may be further comprised of the negative pressure supply source, and the electronic communication means operably connect the control unit to the at least one sensor member. In other embodiments, the negative pressure supply source may be comprised of a portable vacuum pump. In yet other embodiments, the apparatus may further comprise a head casing and body/head enclosure sealing means (which are described in more detail below) to seal the portion of the head enclosure that is positioned adjacent to the whole body enclosure to the whole body enclosure, so that the volume within the head enclosure is not in fluid communication with the ambient environment or the volume within the whole body enclosure. The head casing further comprises a head enclosure having a head enclosure opening. The head enclosure is fluid-impermeable and is not adversely affected by the hazardous materials. It is also of a size and shape adapted to be placed over and enclose the head and neck portions of the body that are not enclosed by the whole body enclosure. In addition, it is adapted to have the portion surrounding the head enclosure opening of the head enclosure positioned adjacent to the portion of the whole body enclosure that surrounds the enclosure opening at the end of the neck portion of the whole body enclosure. In some of these embodiments, the apparatus may further comprise an air supply source and air supply source connection means to operably connect the air supply source to the head enclosure, so that a supply of breathable gas may be supplied to the volume within the head enclosure by the air supply source. In yet other embodiments, the negative pressure maintained in the volume within the whole body enclosure is in the range between 40 mm Hg and 150 mm Hg.

There has thus been outlined, rather broadly, the more primary features of the present invention. There are additional features that are also included in the various embodiments of the invention that are described hereinafter and that form the subject matter of the claims appended hereto. In this respect, it is to be understood that the invention is not limited in its application to the details of construction and to the arrangements of the components set forth in the following description or illustrated in the following drawings. This invention may be embodied in the form illustrated in the accompanying drawings, but the drawings are illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The foregoing summary, as well as the following detailed description of the preferred embodiments of the present invention, will be better understood when read in conjunction with the appended drawings, in which:

FIG. 1A is a partially broken away perspective view of an embodiment of an apparatus comprising the present invention;

FIG. 1B is a partially broken away perspective view of another embodiment of an apparatus comprising the present invention;

FIG. 2A is a partially broken away perspective view of an embodiment of a hand casing, which extremity casing comprises an aspect of the present invention;

FIG. 2B is a partially broken away perspective view of another embodiment of an apparatus comprising the present invention;

FIG. 2C is an enlarged perspective view of the casing connector utilized by the embodiment of the hand casing illustrated in FIG. 2A;

FIG. 2D is a schematic diagram of an embodiment of a control unit utilized by the embodiment of the hand casing illustrated in FIG. 2B; and

FIG. 3 is a partially broken away perspective view of an embodiment of a foot casing, which extremity casing comprises an aspect of the present invention.

### DETAILED DESCRIPTION OF THE PREFERRED EMBODIMENTS

In accordance with the present invention, a negative pressure protection system is provided for protecting all or a portion of the body of a person against hazardous environments by covering all or a portion of the body, respectively, with a fluid-impermeable casing and by applying negative pressure to the fluid-impermeable casing in a controlled manner that overcomes the disadvantages of currently existing apparatus. As used herein, “negative pressure” is pressure that is below the pressure of the ambient environment. For example, if the system is being used in an environment that is at atmospheric pressure, the negative pressure utilized by the system of the present invention is less than ambient atmospheric pressure. In addition, the term “fluid” includes liquids, gases and combinations thereof Further, references to the “ambient environment” are to the environment that exists outside the exterior surface of the various components of the negative pressure protection system. Further still, references to toxins and hazardous materials, liquids, gases and other substances are to materials that are generally hazardous to the life or health of living organisms.

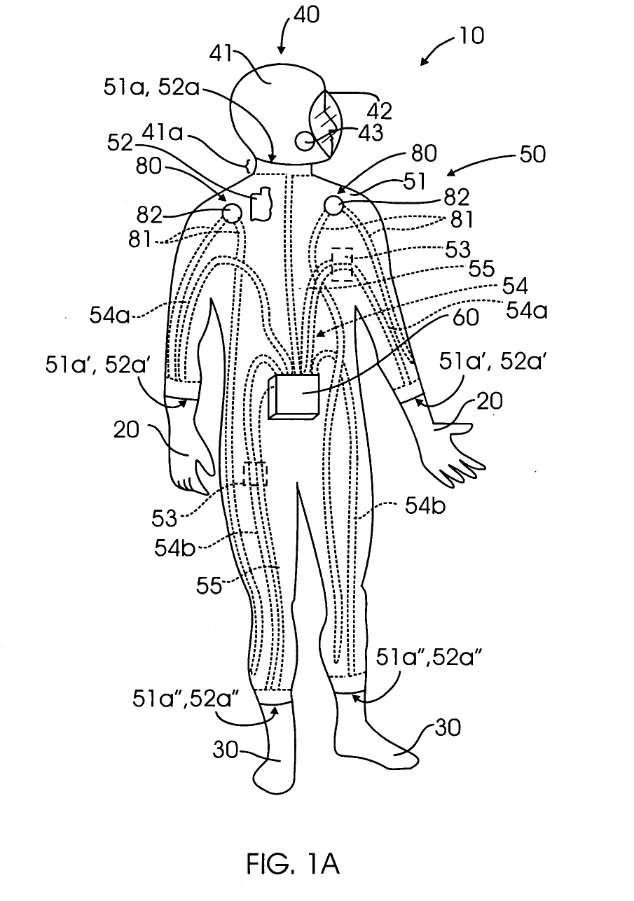

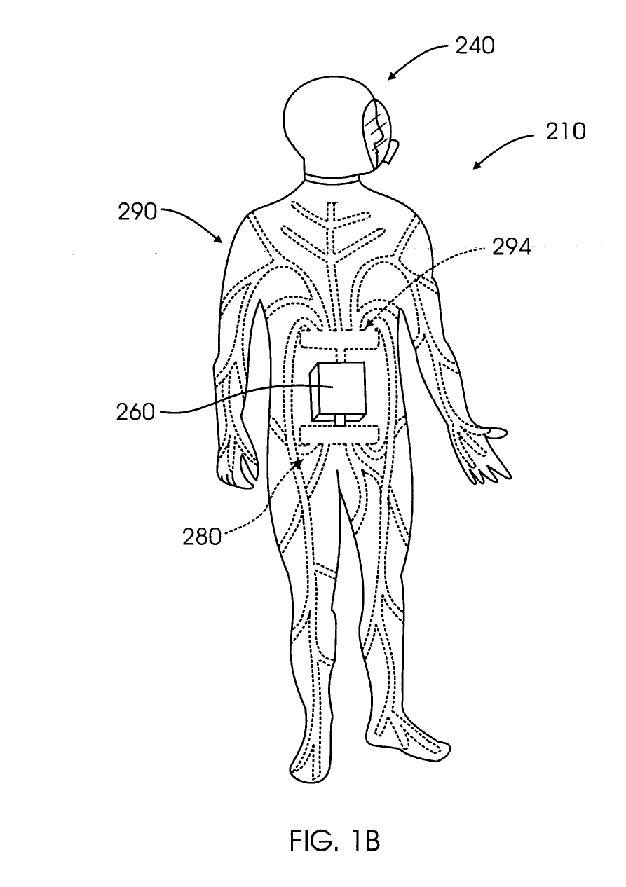

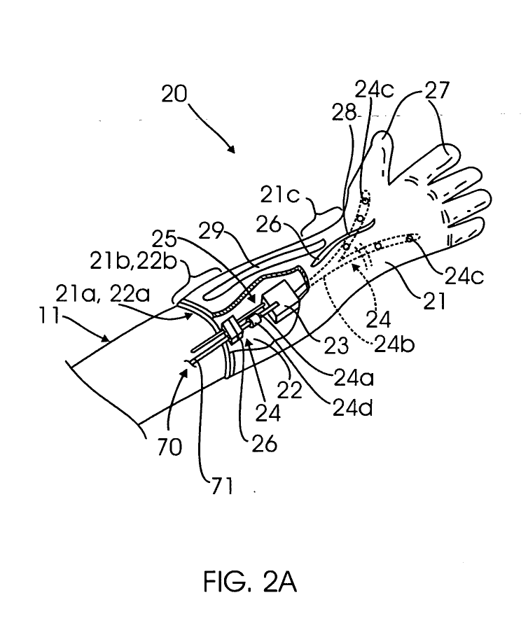

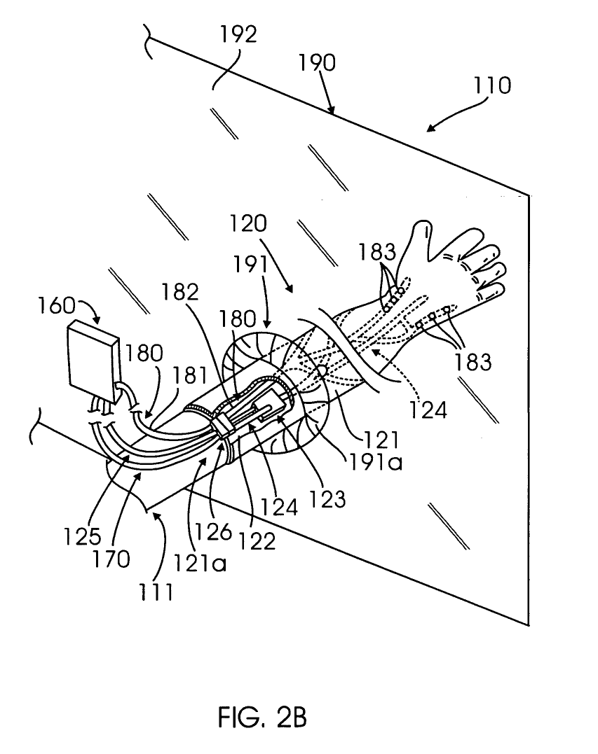

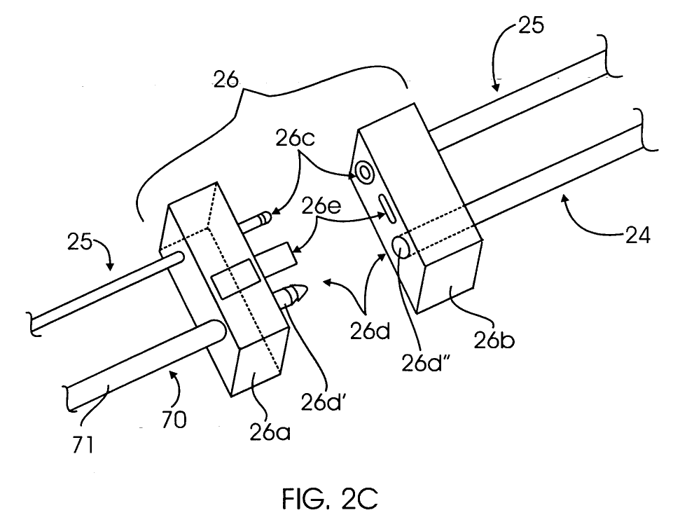

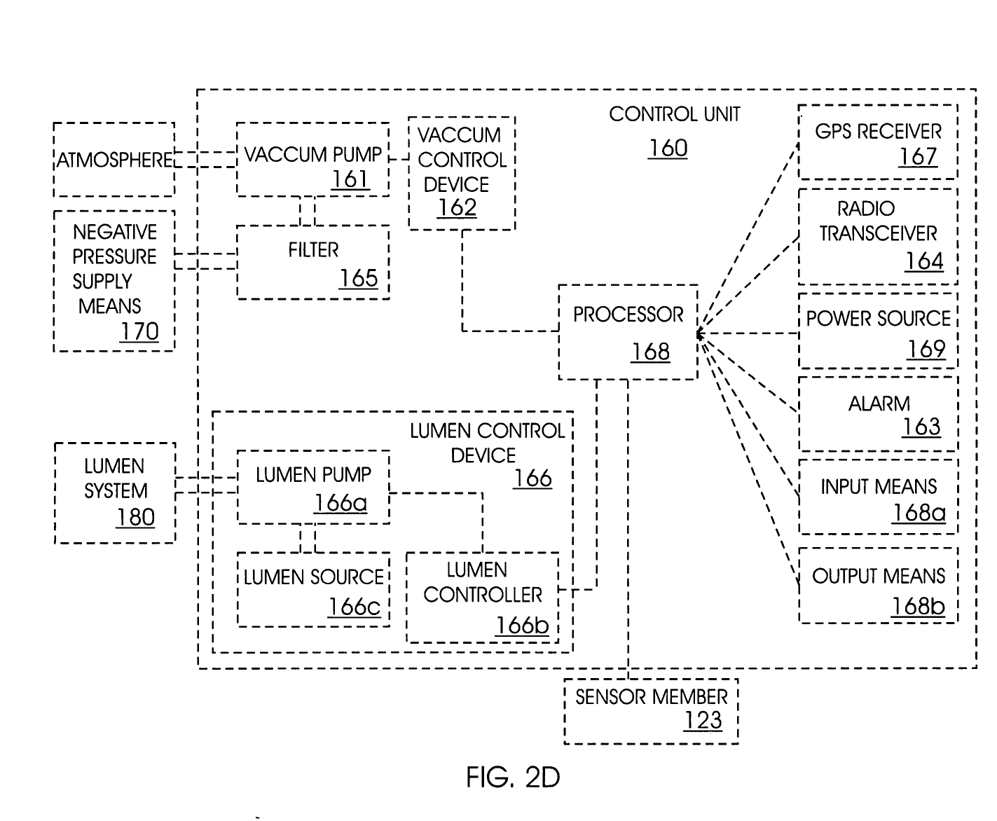

One embodiment of a first version of the present invention is the apparatus 10 illustrated in FIG. 1A. In this embodiment, the apparatus 10 is generally comprised of two extremity casings in the approximate shape of a hand, wrist and forearm or portion of the forearm (hand casings 20), two extremity casings in the approximate shape of a foot, ankle and, in some cases, lower leg or portion of a lower leg (foot casings 30), a head casing 40, a partial body casing 50, and a control unit 60. The hand casings 20 and the foot casings 30 are each permanently or removably sealed to the partial body casing 50 using body/extremity sealing means, which are described in more detail below. The body/extremity sealing means provide for a fluid-tight seal between the partial body casing 50 and each of the hand casings 20 and foot casings 30, so that fluids from the ambient environment are not permitted access to the volume within the hand casings 20, the foot casings 30, and the partial body casing 50. The body/extremity sealing means are also not adversely affected by the hazardous materials. In addition, the head casing 40 may be permanently or removably sealed to the partial body casing 50 using body/head sealing means, which are described in more detail below. The body/head sealing means provide for a fluid-tight seal between the head casing 40 and the partial body casing 50, so that fluids from the ambient environment are not permitted access to the volume within the head casing 40 and the partial body casing 50. The body/head sealing means are also not adversely affected by the hazardous materials. The control unit 60, which is described in more detail below, generally monitors and controls the operation of the apparatus 10. It also allows for operating communication between the apparatus 10 and its user or others involved in monitoring the activities of the user, or both. For example, the control unit 60 may monitor humidity, temperature, and toxin and pressure levels within various portions of the apparatus 10. It may also control the level of negative pressure in various portions of the apparatus 10, as well as control the application of other gases into the apparatus 10, such as for cooling, heating and ventilation purposes. The control unit 60 may also sound alarms for the user and communicate such alarms by radio frequency transmission to others. It may also cause mechanisms comprising the apparatus 10 to take corrective action if certain parameters (such as toxin levels) exceed specified thresholds. It is to be noted that the preceding description is only a partial list of the functions that may be performed by the control unit 60. The control unit 60 may be removably or permanently attached to the partial body casing 50 in the location illustrated in FIG. 1A. Alternatively, the control unit 60 may be removably or permanently attached to another portion of the apparatus 10, or it may be positioned remotely from the partial body casing 50, the hand casings 20, the foot casings 30, and the head casing 40. Generally, the control unit 60 may have substantially the same structure, features, characteristics and operation as the control unit 160, as described below and illustrated in connection with FIG. 2B and FIG. 2D.

An enlarged, partially broken away perspective view of an embodiment of a hand casing 20 is illustrated in FIG. 2A. In this embodiment, the hand casing 20 is generally comprised of an extremity enclosure in the approximate shape of a hand, wrist and forearm or portion of the forearm (hand enclosure 21), a liner in the approximate shape of a hand, wrist and forearm or portion of the forearm (hand liner 22), at least one sensor member 23, negative pressure distribution means 24, electronic communication means 25, a casing connector 26, and extremity enclosure sealing means and negative pressure supply means 70, both of which are described in more detail below. It is to be noted that the hand casing 20 may be used as a part of the apparatus 10 illustrated in FIG. 1A, or other embodiments or aspects of the apparatus 10. In such cases, the hand casing 20 may be removably or permanently sealed to the partial body casing 50, as briefly described above in connection with FIG. 1A, and as described in more detail below, using the body/extremity sealing means. Alternatively, the hand casing 20 may be used alone with a separate control unit (not illustrated). For example, a user may place the hand casing 20 on his or her hand, wrist and forearm to perform functions in a tank containing hazardous liquid, such as rinsing a manufactured part in a tank containing a solvent. In this case, the hand casing 20 may be sealed to the portion of the user's arm 11 approximately adjacent to the opening 21a of the hand enclosure 21 using extremity enclosure sealing means, which are described in more detail below. Alternatively, the hand enclosure 21 may be sealed to the hand liner 22 using the extremity enclosure sealing means (described in more detail below), which is then sealed to the portion of the person's arm 11 approximately adjacent to the opening 22a of the hand liner 22 using the extremity enclosure sealing means. The extremity enclosure sealing means provide a fluid-tight seal, so that negative pressure may be maintained in the volume within the hand casing 20. The extremity enclosure sealing means may or may not be utilized in embodiments where the hand casing 20 is used with the apparatus 10 illustrated in FIG. 1A, or other embodiments or aspects of the apparatus 10. As yet another alternative, the hand casing 20 may be used in connection with other applications. For example, in the apparatus 110 illustrated in FIG. 2B, the hand casing 120 may be used to provide access to a ventilated hood enclosure 190 so that the user may manipulate objects within the enclosure 190 without having direct contact with the ambient environment in the enclosure 190. Use of the hand casing 120 in this type of application is also described in more detail below. As another example, the hand casing 20 may be used in conjunction with conventional protective suits. It is to be noted that in some applications where the use of the hand casing 20 requires it, the hand enclosure 21 and the hand liner 22 may extend to cover additional portions of the arm 11 of the user, such as the hand, wrist and arm up to the shoulder.

Referring again to FIG. 2A, the hand enclosure 21 is generally sized to be placed over and enclose the hand, wrist and forearm (or a portion of the arm 11) of the user of the hand casing 20. The hand enclosure 21 and the extremity enclosure sealing means (described in more detail below) allow negative pressure to be maintained in the volume within the hand enclosure 21 at the hand, wrist and portion of the arm 11 covered by the hand enclosure 21. The negative pressure supply means 70 (described in more detail below) are used to operably connect the negative pressure distribution means 24 of the hand casing 20 to a control unit, which is not illustrated in FIG. 2A, but which may be the control unit 60 in embodiments where the hand casing 20 is used as a part of the apparatus 10 described herein and illustrated in connection with FIG. 1A (or other embodiments or aspects of the apparatus 10). The control unit generally includes a negative pressure supply source (also not illustrated), which provides a supply of negative pressure to the hand casing 20, so that the volume within the hand enclosure 21 at the 10 portion of the hand, wrist and arm 11 covered by the hand enclosure 21 may be maintained at negative pressure. In the various embodiments of the hand casing 20, the hand enclosure 21 may be comprised of any flexible material that is currently known in the art or that may be developed in the art in the future that is fluid-impermeable, is not adversely affected by any contents present in the ambient environment (for example, does not break down or become rigid or brittle in the presence of any materials present in the ambient environment), has adequate strength to maintain its integrity during its intended use, and is otherwise suitable for its intended purposes of protecting the user from exposure to the ambient environment and maintaining reduced pressure in the volume within the hand enclosure 21. For example, the hand enclosure 21 may be comprised of rubber (including neoprene), polyvinyl chloride, NITRIL, PVA, fluoro-elastomer, NORFOIL, polyurethane, LATEX, TYVEK, or other flexible polymer materials, or combinations of any such materials. The preferred material is also dependent upon the anticipated use of the hand casing 20, the materials present in the anticipated ambient environment, the anticipated temperature of the ambient environment, and the preference of the user of the appliance 10. For example, for a hand casing 20 used as part of an apparatus (such as the apparatus 10 illustrated in FIG. 1A) to conduct fire rescue operations in a building filled with smoke, the hand enclosure 21 is preferably comprised of fire retardant or high temperature cloth with a LATEX or equivalent overlay. In some embodiments, all portions of the hand enclosure 21 are preferably constructed of one type of flexible material. In some of these embodiments, the thickness of various portions of the hand enclosure 21 may vary in order to vary the level of pressure exerted by the hand enclosure 21 at the portion of the body adjacent to the portions. For example, the thumb and finger portions 27 of the hand enclosure 21 may have a lesser thickness than the remaining portion of the hand enclosure 21. In these embodiments, the thumb and finger portions 27 of the hand enclosure 21 may have a greater flexibility than the remaining portions of the hand enclosure 21. In addition, the remaining portions of the hand enclosure 21 may not collapse against the adjacent portions of the body with the same force as the thumb and finger portions 27 of the hand enclosure 21 collapse against the thumb and fingers, respectively, when suction is produced by the application of negative pressure in the volume within the hand enclosure 21. The reason is the increased stiffness of the remaining portions of the hand enclosure 21 caused by the increased thickness of such portions. In yet other embodiments, the hand enclosure 21 may be of a thickness so that at least one fold 28 forms in the surface of the hand enclosure 21 when negative pressure is present under the hand enclosure 21 at the portion of the body enclosed by the hand enclosure 21. In these embodiments, the at least one fold 28 may act as a channel to distribute negative pressure throughout the volume within the hand enclosure 21. It is also to be noted that in various embodiments different portions of the hand enclosure 21 may be constructed of different materials. For example, the portion 21b of the hand enclosure 21 adjacent to the opening 21a may be constructed of a more flexible material than the remaining portions of the hand enclosure 21 to provide for a more effective extremity enclosure sealing means, as described in more detail below. Similarly, the thumb and finger portions 27 of the hand enclosure 21 may be constructed of a more flexible material than the remaining portion of the hand enclosure 21, providing the thumb and finger portions 27 of the hand enclosure 21 greater flexibility than the remaining portions of the hand enclosure 21. In other embodiments, the hand enclosure 21 may also be comprised of at least one portion constructed of a rigid or semi-rigid material. Generally, in these embodiments, the at least one portion of the hand enclosure 21 constructed of a rigid or semi-rigid material may be positioned approximately adjacent to an area of the body requiring a reduced level of pressure or an increased degree of support. For example, a portion 21c of the hand enclosure 21 adjacent to the wrist portion of the user may be constructed of a rigid or semi-rigid material to provide support for the user's wrist. In some of the embodiments comprising at least one rigid or semi-rigid portion, such portion may be constructed of metals, wood, ceramics, plastics and other polymers, such as polyvinyl chloride, or combinations of such materials. Generally, the hand enclosure 21 may be constructed using any suitable means currently known in the art or that may be developed in the art in the future. For example, a hand enclosure 21 constructed entirely of silicone, polyurethane or LATEX may be manufactured by means of injection molding. As another example, embodiments of hand enclosures 21 constructed of different types of materials may be constructed by fusing or welding such portions together. The preferred wall thickness of the hand enclosure 21 is dependent upon the size of the hand enclosure 21, the magnitude of the reduced pressure to be maintained under the hand enclosure 21, the degree of dexterity desired in performing tasks using the hand casing 20, the materials and other conditions present in the ambient environment, the materials comprising the hand enclosure 21, and the individual preferences of the user of the hand casing 20. For example, for a hand enclosure 21 constructed entirely of LATEX, polyurethane, or TYVEK, sized to fit a standard adult male hand, being of a uniform thickness, for performing hazardous material remediation work in an ambient environment having a temperature in the range from 45 to 95 degrees F., the preferred thickness of the hand enclosure 21 is in the range from 0.02 inches to 0.1 inches. It is to be noted that in other embodiments the thickness of the hand enclosure 21, including any rigid or semi-rigid portions of the hand enclosure 21, may vary from embodiment to embodiment, as well as from location to location on the hand enclosure 21.

In some embodiments, the hand enclosure 21 may be further comprised of at least one panel 29 positioned thereon. Although the hand enclosure 21 illustrated in FIG. 2A has one panel 29, in other embodiments there may be almost any number of panels 29 used with any number of areas of the hand enclosure 21, as desired to provide support for various portions of the hand enclosure 21. For example, in the illustrated embodiment, the panel 29 is comprised of a rigid or semi-rigid material and may be permanently or removably attached to the surface of the hand enclosure 21. The panel 29 may be used to provide support for a portion of the body (the forearm and wrist, in the case of use of the hand enclosure 21) during use of the hand casing 20. In the case of permanent attachment, the panel 29 may be attached to the hand enclosure 21 by means of adhesives, glues, welding, fusing, rivets, screws, clasps, nuts and bolts, or other fasteners or combination of such means. In the case of removable attachment, the panel 29 may be attached to the hand enclosure 21 by means of hook and loop fasteners (such as VELCRO), zippers, or other detachable connectors or combinations of such means. In other embodiments, the panel 29 may be slid into pockets or sheaths that are located on a surface of the hand enclosure 21. In various embodiments, one or more of the panels 29 may be adapted to conform to the shape of at least a part of the adjacent body portion so that the panels 29 support such part in a manner comfortable for the user. In various embodiments, the panel 29 may be comprised of a rigid or semi-rigid material or both. In some of these embodiments, the at least one panel 29 may be comprised of metals, wood, ceramics, plastics and other polymers, or combinations of such materials.

In the illustrated embodiment, the hand casing 20 is also comprised of a hand liner 22. It is to be noted that the hand liner 22 may be used, and is preferably used, with the hand casing 20. In other embodiments, however, the hand casing 20 may be used without the hand liner 22. The hand liner 22 serves to protect the skin of the user that is adjacent to the hand casing 20 in some embodiments. In other embodiments, the hand liner 22 serves to prevent fluids emitted from the portion of the body adjacent to the hand casing 20 from reaching the volume between the hand liner 22 and the hand enclosure 21, so that such fluid does not activate the sensor member 23, such as humidity detection means that may be a part of the sensor member 23. Where the hand liner 22 is utilized, the hand enclosure 21 may be sealed to the hand liner 22, which may then be sealed to the portion of the person's arm 11 approximately adjacent to the opening 22a of the hand liner 22 using the extremity enclosure sealing means, which are described in more detail below. The extremity enclosure sealing means provide a fluid-tight seal, so that negative pressure may be maintained in the volume within the hand casing 20. The hand enclosure 21 may also generally be sealed to the hand liner 22 using the extremity enclosure sealing means described in more detail below. Alternatively, the hand enclosure 21 may be sealed to the hand liner 22 using any other suitable type of fluid-tight seal, which may also be considered extremity enclosure sealing means. For example, the hand enclosure 21 may be sealed to the hand liner 22 by means of welding (including ultra sound and radio frequency welding), fusing (including heat sealing), adhesives, glues, epoxies, agent bonding, or combinations of such means. As is the case with the hand enclosure 21, the hand liner 22 is generally sized to be placed over and enclose the hand, wrist and forearm (or other portion of the arm 11) of the user of the hand casing 20. Although the hand liner 22 preferably extends the same distance along the arm 11 as the hand enclosure 21, as illustrated in FIG. 2A, the hand liner 22 may extend further along the arm 11 than the hand enclosure 21, or it may not extend as far along the arm 11 as the hand enclosure 21. In the various embodiments of the hand casing 20, the hand liner 22 may be comprised of any flexible material that is currently known in the art or that may be developed in the art in the future that is fluid-impermeable, is not adversely affected by any contents present in the ambient environment (for example, does not break down or become rigid or brittle in the presence of any materials present in the environment), has adequate strength to maintain its integrity during its intended use, and is otherwise suitable for its intended purposes of protecting the user from exposure to the ambient environment and maintaining reduced pressure in the volume within the hand enclosure 21. For example, the hand liner 22 may be comprised of materials similar to those comprising the hand enclosure 22, or it may be comprised of LATEX, TYVEK, polyurethane, nylon or combinations of such materials. The preferred material is also dependent upon the anticipated use of the hand casing 20, the materials present in the anticipated ambient environment, the anticipated temperature of the ambient environment, the material comprising the hand enclosure 21, and the preference of the user of the hand casing 20. In addition, the hand liner 22 may have a layer of soft, pliable material for the comfort of the user, such as cotton, cotton-polyester blend, linen or other cloth or material or combinations of such materials (not illustrated), on the interior surface of the hand liner 22. It is to be noted, however, that in some embodiments, the hand liner 22 may be constructed of a material that is liquid-impermeable, but not gas-impermeable. In these embodiments, the hand liner 22 allows the portion of the hand, wrist and arm 11 adjacent to the hand liner 22 to “breathe.” Although the hand liner 22 may be comprised of one or more different materials, may have portions of differing thickness, and may have one or more panels, as is the case for the hand enclosure 21, the hand liner 22 is preferably comprised of a single material of approximately uniform thickness without panels. Generally, the hand liner 22 may be constructed using any suitable means currently known in the art or that may be developed in the art in the future, such as those that may be used to construct the hand enclosure 21, as described in more detail above. The preferred thickness of the hand liner 22 is dependent upon the size and thickness of the hand enclosure 21, the magnitude of the reduced pressure to be maintained under the hand enclosure 21, the degree of dexterity desired in performing tasks using the hand casing 20, the materials and other conditions present in the ambient environment, the materials comprising the hand liner 22 and the hand enclosure 21, and the individual preferences of the user of the hand casing 20. More preferred in this embodiment, the hand liner 22 is comprised of LATEX with an interior layer of cotton-polyester blend, and the thickness of the hand liner 22 is in the range from 0.02 inches to 0.1 inches.

The hand enclosure 21, or the hand liner 22 in some embodiments, of the hand casing 20 may be sealed to the portion of the user's arm 11 approximately adjacent to the opening 21a, 22a of the hand enclosure 21 or hand liner 22, respectively, by the extremity enclosure sealing means. In the embodiment illustrated in FIG. 2A, the interior surface of the portion 22b of the hand liner 22 positioned around and adjacent to the perimeter of the opening 22a of the hand liner 22 is in contact with the surface of the portion of the arm 11 of the user adjacent to such portion 22b. Such contact may be created by the portion 22b of the hand liner 22 positioned around and adjacent to the perimeter of the opening 22a of the hand liner 22 being constructed of a flexible material having a circumference in the relaxed state that is less than the circumference of the portion of the user's arm 11 that is adjacent to such portion 22b. The portion 22b is stretched to enclose the user's arm 11, and when relaxed, the portion 22b is held tightly against the adjacent portion of the user's arm 11. The interior surface of the portion 21b of the hand enclosure 21 positioned around and adjacent to the perimeter of the opening 21a of the hand enclosure 21 may be held against the portion 22b of the hand liner 22 using the same type of mechanism. Alternatively, the user of the hand casing 20 may exert mild pressure on the portion 21b of the hand enclosure 21 positioned around and adjacent to the perimeter of the opening 21a of the hand enclosure 21, so that such portion 21b of the hand enclosure 21 is held against the portion 22b of the hand liner 22 positioned around and adjacent to the perimeter of the opening 22a of the hand liner 22. Negative pressure may then be supplied to the hand casing 20 by means of the negative pressure supply means 70 cooperating with the negative pressure supply source, both of which are described in more detail below. When negative pressure is applied to the volume within the hand enclosure 21, the hand enclosure 21 is drawn downward by the negative pressure, collapsing the hand enclosure 21 in the approximate direction of the portion of the user's arm 11 that is adjacent to the hand liner 22. As the hand enclosure 21 collapses, the portion 21b of the hand enclosure 21 adjacent to the perimeter of the opening 21a of the hand enclosure 21 is drawn tightly against the adjacent portion of the hand liner 22, thus forming a fluid-tight seal between the portion 21b of the hand enclosure 21 adjacent to the portion 22b of the hand liner 22. In embodiments where all or a part of the portion 21b adjacent to the perimeter of the opening 21a of the hand enclosure 21 is adjacent to a portion of the arm 11 of the user of the hand casing 20, such portion 21b may form a fluid-tight seal between such portion 21b and the adjacent portion of the arm 11 of the user. In some embodiments, it may be necessary to provide other extremity enclosure sealing means (not illustrated) to provide a fluid-tight seal between the portions 21b, 22b of the hand enclosure 21 or hand liner 22, or both, and the portion of the arm 11 of the user adjacent to such portions 21b, 22b. For example, the extremity enclosure sealing means may be an adhesive applied to the portions 21b, 22b of the hand enclosure 21 or hand liner 22, or both, or to a portion of the arm 11 of the user adjacent to such portions 21b, 22b. In other embodiments, the extremity enclosure sealing means may be comprised of almost any suitable means to provide an adequate fluid-tight seal. For example, the extremity enclosure sealing means may be comprised of an adhesive, an adhesive tape, lanoline, a hydrocolloid material, or a stretch fabric that is wrapped around the arm 11 of the user and covers either or both of the portions 21b, 22b, or a combination of such means. It is to be noted that some of the extremity enclosure sealing means, such as welding, are not suitable for use in sealing the hand enclosure 21 or the hand liner 22 to the body.

As illustrated in FIG. 2A, the hand casing 20 is also comprised of negative pressure distribution means 24, which assists in the distribution of negative pressure received from the negative pressure supply source by means of the negative pressure supply means 70 throughout the volume within the hand enclosure 21. In the illustrated embodiment, the negative pressure distribution means 24 is generally comprised of a connection tubing member 24a and a distribution tubing member 24b. The connection tubing member 24a generally extends from the casing connector 26 to the sensor member 23. The casing connector 26, among other things (as described in more detail below), operably connects the connection tubing member 24a to the 10 negative pressure supply means 70 (also described in more detail below), so that the connection tubing member 24a is in fluid communication with the negative pressure supply means 70. The distribution tubing member 24b is operably connected to the connection tubing member 24a at the sensor member 23 so that the distribution tubing member 24b is in fluid communication with the connection tubing member 24a. The distribution tubing member 24b extends from the sensor member 23 into the volume within the hand enclosure 21. In the illustrated embodiment, the connection tubing member 24a and the distribution tubing member 24b are comprised of flexible tubing that is flexible enough to bend with the hand casing 20 as the user moves, but is rigid enough to avoid collapsing under the pressure exerted on the connection tubing member 24a and the distribution tubing member 24b in normal use of the hand casing 20. The connection tubing member 24a and the distribution tubing member 24b may, but need not necessarily be, comprised of the same material as the hand enclosure 21. The preferred size of the connection tubing member 24a and the distribution tubing member 24b is dependent upon the size and shape of the hand enclosure 21, the level of negative pressure to be maintained within the volume of the hand enclosure 21, and the preference of the user of the appliance 10. Typically, as illustrated in FIG. 2A, the distribution tubing member 24b has a plurality of perforations 24c that open into the volume within the hand enclosure 21. The perforations 24c serve to further assist in distribution of negative pressure throughout the volume within the hand enclosure 21. Thus, after the hand casing member 20 is sealed to the arm 11 of the user and negative pressure is applied to the hand casing 20 by means of the negative pressure supply source cooperating with the negative pressure supply means 70 (both of which are described in more detail below) to the connection tubing member 24a and the distribution tubing member 24b, the fluids (typically air) within the hand enclosure 21 are drawn through the distribution tubing member 24b into the connection tubing member 24a and out of the hand casing 20 by the negative pressure supply means 70. It is to be noted that in various embodiments, the connection tubing member 24a or the distribution tubing member 24b, or both, may be further comprised of a filter (not illustrated) operably positioned therein that may be used to remove any moisture or hazardous materials (or both) that may have entered into the volume within the hand casing 20. Such filters are well known in the relevant art. It is also to be noted that in various embodiments, the connection tubing member 24a or the distribution tubing member 24b, or both, may be further comprised of at least one check valve 24d operably positioned therein that may be used to stop the flow of fluids from the volume within the hand casing 20 into the reduced pressure supply means 70. This may be desirable where hazardous materials may have entered into the volume within the hand casing 20. The at least one check valve, which are well known in the relevant art, may be operated by the sensor member 23 or the control unit. Further, it is to be noted that although the connection tubing member 24a and the distribution tubing member 24b have the shape, size and configuration illustrated in FIG. 2A in this particular embodiment, they may have different shapes, sizes and configurations in other embodiments of the hand casing 20. For example, in some embodiments the connection tubing member 24a and the distribution tubing member 24b may be a single piece, as in cases where the sensor member 23 may not be used to monitor the contents of the connection tubing member 24a and the distribution tubing member 24b. In other embodiments, the distribution tubing member 24b may not be present, or may be much shorter than illustrated. In yet other embodiments, the distribution tubing member 24b may have a different pattern and orientation of tubing branches. For example, the distribution tubing member 24b may be comprised of a single length of tubing or may have three or more tubing branches. In addition, the distribution tubing member 24b may have tubing branches that extend around to the other side of the hand casing 20. In still other embodiments, the connection tubing member 24a may enter the hand casing 20 in a different location, such as at the opening 21a of the hand enclosure 21 on the other side of the hand casing 20, or at a location on the wrist portion 21c of the hand enclosure 21. Although the connection tubing member 24a and the distribution tubing member 24b are annular in shape (when viewed cross-sectionally) in the illustrated embodiment, they may have other shapes in other embodiments. For example, the exterior or interior (or both) cross-sections of the connection tubing member 24a and the distribution tubing member 24b may be shaped as an ellipse, triangle, square, rectangle, or other polyhedral shape or shape having any linear or arcuate portions, or any combination of such shapes. Further, the connection tubing member 24a or the distribution tubing member 24b, or both, may be attached to the hand enclosure 21 or the hand liner 22, or both, along part or all of their respective lengths. In such cases, the connection tubing member 24a and the distribution tubing member 24b may be attached using any suitable means, such as welding (including ultra sound and radio frequency welding), fusing (including heat sealing), adhesives, glues, epoxies, clasps, clamps, agent bonding, or combinations of such means. Alternatively, portions of the connection tubing member 24a and the distribution tubing member 24b may not be connected to any portion of the hand casing 20. In still other embodiments, the connection tubing member 24a or the distribution tubing member 24b, or both, may be located in whole or in part on the interior surface or exterior surface of the hand enclosure 21. If they are located on the exterior surface of the hand enclosure 21, the perforations 24c may penetrate the wall of the hand enclosure 21 to provide fluid communication between the volume within the hand enclosure 21 and the connection tubing member 24a and the distribution tubing member 24b. In other embodiments, the connection tubing member 24a or the distribution tubing member 24b, or both, may be located in whole or in part on the interior surface (the surface facing the body of the user) or exterior surface of the hand liner 22. If they are located on the interior surface of the hand liner 22, the perforations 24c may penetrate the wall of the hand liner 22 to provide fluid communication between the volume within the hand enclosure 21 and the connection tubing member 24a and the distribution tubing member 24b. In still other embodiments, the connection tubing member 24a or the distribution tubing member 24b, or both, may be embedded in whole or in part within the hand enclosure 21 or the hand liner 22. In such cases, the connection tubing member 24a or the distribution tubing member 24b may be fabricated as a single piece with the hand enclosure 21 or the hand liner 22, respectively. Alternatively, the embedded connection tubing member 24a or the embedded distribution tubing member 24b may be created by forming channels or grooves in one piece (such as a sheet) of material that will comprise the hand enclosure 21 or the hand liner 22 and then attaching another piece (such as a sheet) of material to the first piece, wherein the other piece has perforations 24c therein that will be positioned over the channels or grooves. In other embodiments, the negative pressure distribution means 24 may be comprised of channels (not illustrated) recessed into the interior surface of the hand enclosure 21. The channels generally provide for suctioned fluids to flow along such channels to the negative pressure supply means 70, where the fluids may be removed from the hand enclosure 21 by means of the reduced pressure supply means 70 cooperating with the reduced pressure supply source, as described in more detail below. In some of these embodiments, the channels may be operably connected to the reduced pressure supply means 70 through a port (not illustrated) that is connected to the casing connector 26 or through a cooperating tubular connection tubing member 24a or a distribution tubing member 24b or both. The channels may be of almost any size and shape to accomplish their intended purpose, such as u-shaped or v-shaped grooves. The preferred size and shape is dependent upon the size and shape of the hand enclosure 21, the type of cooperating connection tubing member 24a and the distribution tubing member 24b present, if any, the level of reduced pressure to be maintained in the volume within the hand enclosure 21, and the individual preference of the user of the hand casing 20. Where utilized, channels may be molded or cut into the interior surface of the hand enclosure 21.

In the embodiment of the present invention illustrated in FIG. 2A, the hand casing 20 is further comprised of electronic communication means 25. The electronic communication means 25 generally connects a control unit (not illustrated, but which may be the control unit 60 described herein and illustrated in connection with FIG. 1A in some embodiments of the present invention) to the sensor member 23. In some embodiments, the electronic communication means 25 may provide electrical power to the sensor member 23 for operation of the electronic components comprising the sensor member 23. The electrical power is generally produced by a power source that is included within the control unit. In addition, the electronic communication means 25 may also provide a means for commands formulated by the control unit to be communicated to the sensor member 23 or the valve 24d. Further, the electronic communication means 25 may also provide a means for information produced by the sensor member 23 to be 20 communicated electronically to the control unit. It is to be noted that there may not be any electronic communication means 25 comprising the hand casing 20 in some embodiments. In other embodiments, the electronic communication means 25 may serve one or more of the functions described above, but not all of such functions. In various embodiments of the present invention, the electronic communication means 25 may be comprised of any type of medium, or combination of types of media, that provide for the transfer of electrical power and electronic communications. For example, the electronic communication means 25 may be comprised of metallic conducting materials (such as copper or aluminum wire), optical fibers, radio frequency transmitters or receivers (or both), other electronic communication means, or combinations of such means. The preferred means is generally dependent upon the functions to be served by the electronic communication means 25, the nature of the electrical interference in the ambient environment, and the preference of the user of the appliance 10. More preferably, the electronic communication means 25 is comprised of radio frequency transmitters and receivers. Typically, the electronic communication means is also comprised of an insulating or protective sheath that covers any physical electronic transfer medium (such as copper wire or optical fiber) that comprises the electronic communication means 25. In addition, in the embodiment illustrated in FIG. 2A, the electronic communication means 25 is further comprised (in part) of the casing connector 26.

In the embodiment of the present invention illustrated in FIG. 2A, the hand casing 20 is further comprised of a casing connector 26. An enlarged, detailed illustration of this embodiment of the casing connector 26 is illustrated in FIG. 2C. In this embodiment, the casing connector 26 is comprised of two connector members 26a, 26b, which are removably connected together in the manner described in more detail below. The casing connector 26 is also comprised of electronic connecting means 26c (a plug and socket connector in the illustrated embodiment), which operably connect the portions of the electronic communication means 25 on either side of the casing connector 26 together so that they communicate electronically when the two connector members 26a, 26b are connected together. In various embodiments, the electronic connecting means 26c of the casing connector 26 that are used to connect the portions of the electronic communication means 25 on either side of the casing connector 26 together may be any suitable type connector adapted to connect the type of media comprising the electronic communication means 25. For example, such means may be comprised of multi-lead plug and receptor connectors, such as may be used in telephone and network applications) or combinations of such means. In addition, the casing connector 26 is comprised of negative pressure connecting means 26d, which are used to operably connect the negative pressure supply system 70 (which is described in more detail below) to the negative pressure distribution means 24. In the illustrated embodiment, the negative pressure connecting means 26d are comprised of a barbed connector 26d′ and an open end of flexible tubing 26d″ that receives the barbed connector 26d′ when the two connector members 26a, 26b are removably connected together, so that a fluid-tight seal is created between the flexible tubing 26d″ and the barbed connector 26d′, which is the preferred means. In other embodiments, the negative pressure connecting means 26d of the casing connector 26 that is used to connect the negative pressure supply means 70 (which is described in more detail below) to the negative pressure distribution means 24 may be any suitable type connector adapted to connect the type of media comprising the negative pressure supply means 70 and the negative pressure distribution means 24. For example, such means may be comprised of Luer Lock connectors, other quick-disconnect connectors, or combinations of such connectors. In the illustrated embodiment, the casing connector 26 is also comprised of connecting means 26e to hold the two connector members 26a, 26b together when they are removably connected together. In this embodiment, such means 26e are comprised of a modular raised tab/slot type of connector, which is well known in the art and is commonly used as a removable connecting means for telephone and computer cables. In other embodiments, any suitable means may be used to removably connect the two connector members 26a, 26b together. For example, such means may include clips, clasps, latches, clamps, zippers, other quick-connect/disconnect connectors, or combinations of such means. It is also to be noted that in other embodiments the casing connector 26 may have different shapes and be of different sizes. In addition, the means of connecting the electronic communication means 25 together may be separate from the means of connecting the reduced pressure supply means 70 to the negative pressure distribution means 24. One of the two connecting members 26a, 26b of the casing connector 26 may be attached to the hand enclosure 21 or the hand liner 22 or both in a manner that provides a fluid-tight seal between the connecting member 26a or 26b and the hand enclosure 21 or the hand liner 22 or both. Such means may generally include any of the means that may be used to seal the hand enclosure 21 to the hand liner 22, as described above and illustrated in connection with FIG. 2A.

In the embodiment of the present invention illustrated in FIG. 2A, the hand casing 20 is also comprised of a sensor member 23, which is generally operably connected to the control unit by the electronic communication means 25, so that the sensor member 23 is in electronic communication with the control unit. Although the embodiment of the hand casing 20 illustrated in FIG. 2A only has one sensor member 23, there may be more than one sensor member 23 in other embodiments. In some embodiments, the sensor member 23 may be comprised of sensors and other equipment that are used to gather information and data regarding various parameters that indicate conditions present within the volume of the hand casing 20 or the ambient environment, or both. For example, the sensor member 23 may be comprised of a temperature sensor, such as a thermocouple, that measures temperature in the area of the sensor member 23. The sensor member 23 may also be comprised of a pressure sensor, such as a pressure transducer, to measure the pressure within the volume of the hand enclosure 20. In addition, the sensor member 23 may be comprised of a sensor or other equipment that measures humidity in the area of the sensor member 23. Further, the sensor member 23 may be comprised of a sensor or equipment that detects the presence of certain substances in the area of the sensor member 23. For example, the sensor member 23 may have a smoke detection or toxic material detection sensor (or both) incorporated as a part thereof Such sensors and equipment are well known in the relevant art. Further still, the sensor member 23 may be further comprised of at least one processor that may schedule data sampling rates for such sensors and equipment, receive data from such sensors and equipment, convert data into a form that may be interpreted by the control unit, transmit raw or converted data (or both) to the control unit, perform other additional functions, or perform any combination of any such functions. It is to be noted that in the various embodiments of the hand casing 20, the sensor member 23 may be comprised of almost any sensing means that is small enough to be incorporated as a part of the hand casing 20 that produces data capable of being interpreted by the control unit, either in its raw form or in a converted form produced by the processor. The preferred sensors, equipment and processors to be included as a part of the sensor member 23 are generally dependent upon the characteristics of construction of the hand casing 20 (such as the thickness of the hand enclosure 21), the anticipated use of the hand casing 20, the characteristics of the ambient environment, the data and information related to the conditions within the volume of the hand casing 20 that are desired by the user of the hand casing 20, the characteristics and features of the control unit, and the features preferred by the user of the hand casing 20. In other embodiments, the sensor member 23 may also be comprised of a power source, such as a battery or fuel cell, to provide electrical power to operate the sensors, equipment and processor.

The at least one sensor member 23 may also have any suitable structure. For example, the sensor member 23 may be in the form of an integrated circuit or a printed circuit board (or both) with the sensors and at least one processor connected to the circuit board by soldering, appropriate sockets, or other suitable means. The integrated circuit or the circuit board with the sensors and at least one processor (except the specific sensing means in some cases) may then be covered with an appropriate sealing compound, such as rubber (including neoprene) or silicone, to protect it from the environment within the hand casing 20 and the ambient environment, if necessary. In other embodiments, the sensor member 23 may be comprised of a fluid-tight containment structure that has the sensors, equipment and processors contained therein (except for the specific sensing means where necessary) with appropriate means to electrically connect the included components together. It is also to be noted that in some embodiments, as illustrated in FIG. 2A, the negative pressure distribution means 24 may be routed through the sensor member 23. This may be the case when it is desirable to monitor gases that are flowing through the negative pressure distribution means 24 to the negative pressure supply means 70. In such cases, the sensing means of the appropriate sensor may extend into the interior volume of the negative pressure distribution means 24 (such as the tubing comprising the system 24, as illustrated in FIG. 2A). In other embodiments, the sensor member 23 may also be comprised of a valve (not illustrated) that controls the flow of gases through the negative pressure distribution means 24. In such cases, the valve may close the negative pressure distribution means 24 off from (or reduce the flow to) the negative pressure supply means 70 under certain circumstances, such as where the humidity of the gases in the negative pressure distribution means 24 exceeds a given level, indicating that the integrity of the hand casing 20 has been compromised and liquid has entered into the interior volume of the hand casing 20. It is not necessary, however, that the negative pressure distribution means 24 be routed through the sensor member 23 in all embodiments.

In the embodiment of the present invention illustrated in FIG. 2A, the hand casing 20 is further comprised of negative pressure supply means 70, which are used to connect the negative pressure supply source (which is typically a part of the control unit and is not illustrated) to the hand casing 20 in a manner so that negative pressure is supplied to the volume within the hand enclosure 21 at the portion of the user's hand, wrist and arm 11 that is covered by the hand enclosure 21, as described in more detail below. In the illustrated embodiment, the reduced pressure supply means 70 is comprised of at least one tubing member 71. In this embodiment, the at least one tubing member 71 is sufficiently flexible to permit movement of the at least one tubing member 71, but is sufficiently rigid to resist constriction when negative pressure is supplied to the hand enclosure 21 or when force may be applied against the at least one tubing member 71 during use of the hand casing 20. Also in the illustrated embodiment, the at least one tubing member 71 is connected to the negative pressure distribution means 24 by means of the casing connector 26, as described in more detail above and illustrated in connection with FIG. 2C. In other embodiments, the at least one tubing member 71 may be connected to the negative pressure distribution means 24 by any suitable means. Examples include variable descending diameter adapters (commonly referred to as “Christmas tree” adapters), luer lock fittings and adapters, clamps, and combinations of such means. Alternatively, the at least one tubing member 71 and the negative pressure distribution means 24 may be fabricated as a single piece. In some embodiments where the hand casing 20 is used as a part of the apparatus 10 described in more detail herein and illustrated in connection with FIG. 1A, the negative pressure supply means 70 may be incorporated as a part of the partial body casing 50, as described in more detail below. Further, even though it is not included as a part of the hand casing 20 illustrated in FIG. 2A, in some embodiments the hand casing 20 may also be comprised of a lumen system. In such embodiments, the lumen system may generally have substantially the same type of structure, features, characteristics and operation as any of the embodiments of the lumen system 180 that may be used in connection with the hand casing 120, as described in more detail below and as illustrated in connection with FIG. 2B. Further still, the hand casing 20 may also comprise a control unit (not illustrated). In such embodiments, the control unit may generally have substantially the same type of structure, features, characteristics and operation as any of the embodiments of the control unit 160 that may be used in connection with the hand casing 120, as described in more detail below and as illustrated in connection with FIG. 2B.

Another embodiment of the present invention utilizing a hand casing 120 is illustrated in FIG. 2B. In this embodiment, the apparatus 110 is comprised of a hand casing 120, at least one sensor member 123, an electronic communications system 125, a control unit 160, negative pressure supply means 170, a lumen system 180, and an environmental enclosure, such as a ventilated hood enclosure 190. Also in this embodiment, except as otherwise provided below, the hand casing 120 (including the at least one sensor member 123 and the electronic communications system 125) and the negative pressure supply means 170 may have substantially the same structure, features, characteristics, and operation as any of the embodiments of the hand casing 20 (including the at least one sensor member 23 and the electronic communications system 25, respectively) and negative pressure supply means 70, respectively, described above and illustrated in connection with FIG. 2A and FIG. 2C. In the embodiment of the apparatus 110 illustrated in FIG. 2B, however, the hand casing 120 is positioned in a portal 191 that is positioned in a surface or boundary wall (such as a transparent viewing plate 192) of the ventilated hood enclosure 190. A portal member 191a is generally positioned in the portal 191 of the transparent viewing plate 192 in a manner that creates a fluid-tight seal between the portal member 191a and the transparent viewing plate 192. Such sealing means are well known in the relevant art, and may include adhesives, glues, welding, fusing, rivets, screws, nuts, bolts, washers, clamps, heat sealing, ultra sound welding, or other fasteners or combinations of such means. The portal member 191a is further comprised of portal sealing means (described in more detail below) to seal the portal member 191a to the hand enclosure 121. The portal member 191a may generally be constructed of the same materials that may be used to construct the hand enclosure 121. The portal sealing means may be any suitable means that provides a fluid-tight seal around the entire perimeter of the hand enclosure 121 where it is in contact with the portal member 191a. For example, the enclosure sealing means may be comprised of adhesives, glues, welding (ultra sound and radio frequency welding), fusing (including heat sealing), rivets, screws, nuts, bolts, washers, clamps, agent bonding, or other fasteners or combinations of such means. Thus, the hand casing 120 of the apparatus 110 may be used to provide access to the ventilated hood enclosure 190 so that the user may manipulate objects within the enclosure 190 without having direct contact with the ambient environment in the enclosure 190. The user of the apparatus 110 places his or her hand, wrist and arm 111 into the hand casing 120, seals the hand casing 120 to the portion of the user's arm 111 adjacent to the opening 121a of the hand casing 120, and then applies negative pressure to the hand casing 120 by the negative pressure distribution means 124 cooperating with the reduced pressure supply means 170 and the reduced pressure supply source (not illustrated), which is described in more detail below. In this embodiment, as described in more detail below in connection with FIG. 2D, the negative pressure supply source may be comprised of a vacuum pump, which may be portable vacuum pump, an outlet from a centralized vacuum system (sometimes referred to as “wall suction”), or other source of vacuum currently known in the relevant art or that may be developed in the relevant art in the future.

The apparatus 110 illustrated in FIG. 2B is also comprised of a lumen system 180. The lumen system 180 may provide for the introduction of various fluids into the volume within the hand casing 120. For example, in some embodiments, the lumen system 180 may supply cool fluid (such as air or other fluid) to the hand casing 120 in order to lower the temperature of the hand casing 120, and therefore, cool the hand, wrist and portion of the arm 111 of the user covered by the hand casing 120. Alternatively, the lumen system 180 may supply warm fluid (such as air or other fluid) to the hand casing 120 in order to increase the temperature of the hand casing 120, and therefore, warm the hand, wrist and portion of the arm 111 of the user covered by the hand casing 120. In yet other embodiments, the lumen system 180 may be used to remove fluids from the volume within the hand casing 120. For example, in the event that the user of the apparatus 110 should suffer injury to a portion of his or her hand, wrist or arm 111 that is covered by the hand casing 120, the lumen system 180 may provide a source of suction to remove any exudate emitted by the injury. In these cases, the suction is generally produced by the control unit 160, as described in more detail below. It is also to be noted that the lumen system 180 need not be utilized in all embodiments of the present invention. In the illustrated embodiment, the lumen system 180 is generally comprised of a supply lumen member 181, a distribution lumen member 182, and (in part) a casing connector 126. The supply lumen member 181 connects the control unit 160 to the casing connector 126. The distribution lumen member 182 generally extends from the casing connector 26 into the volume within the hand enclosure 121. The casing connector 126, among other things (as described in more detail herein and illustrated in connection with FIG. 2A), operably and removably connects the distribution lumen member 182 to the supply lumen member 181, so that the distribution lumen member 182 is in fluid communication with the supply lumen member 181. The means utilized by the casing connector 126 to accomplish such connection may have substantially the same structure, features, characteristics, and operation as the means of the casing connector 26 used to operably and removably connect the negative pressure supply means 70 to the connection tubing member 24a, as described above and illustrated in connection with FIG. 2A and FIG. 2C. It is to be noted that the casing connector 126 need not be utilized in all embodiments of the apparatus 110. For example, different types of connectors may be utilized or the supply lumen member 181 and the distribution lumen member 182 may be fabricated as a single piece. In addition, although the distribution lumen member 182 is not routed through the sensor member 123 in the illustrated embodiment, the distribution lumen member 182 may be routed through the sensor member 123 in other embodiments. In such cases, the distribution lumen member 182 may have substantially the same type of connections to the sensor member 123, and the sensor member 123 may perform substantially the same types of functions relative to the distribution lumen member 182, as the sensor member 23 does with respect to the connection tubing member 24a and distribution tubing member 24b, as described above and illustrated in connection with FIG. 2A. In the illustrated embodiment, the supply lumen member 181 and the distribution lumen member 182 are comprised of flexible tubing that is flexible enough to bend with the hand casing 120 as the user moves, but is rigid enough to avoid collapsing under the pressures exerted on the supply lumen member 181 and the distribution lumen member 182 in normal use of the apparatus 110. The supply lumen member 181 and the distribution lumen member 182 may be, but need not necessarily be, comprised of the same material as the hand enclosure 121. The preferred size of the supply lumen member 181 and the distribution lumen member 182 is dependent upon the size and shape of the hand enclosure 121, the level of negative pressure to be maintained within the volume of the hand enclosure 121, the type of fluid to be utilized in the lumen system 180, the rates of fluid flow desired in the lumen system 180, and the preference of the user of the appliance 110. As illustrated in FIG. 2B, the distribution lumen member 182 may have a plurality of perforations 183 that open into the volume within the hand enclosure 121. The perforations 183 may serve to further assist in distribution of introduced fluids or suction throughout the volume within the hand enclosure 121. It is to be noted, however, that although the supply lumen member 181 and the distribution lumen member 182 have the shape, size and configuration illustrated in FIG. 2B in this particular embodiment, they may have different shapes, sizes and configurations in other embodiments of the hand casing 120. For example, in some embodiments the supply lumen member 181 and the distribution lumen member 182 may be a single piece. In other embodiments, the distribution lumen member 182 may not be present, or may be much shorter than illustrated. In yet other embodiments, the distribution lumen member 182 may have a different pattern or orientation of tubing branches. For example, the distribution lumen member 182 may be comprised of a single length of tubing or may have three or more tubing branches. In addition, the distribution lumen member 182 may have tubing branches that extend around to the other side of the hand casing 120. In still other embodiments, the supply lumen member 181 and the distribution lumen member 182 may enter the hand casing 120 in a different location, such as at the opening 121a of the hand enclosure 121 on the other side of the hand casing 120, or at a location on the forearm portion of the hand enclosure 121. Although the supply lumen member 181 and the distribution lumen member 182 are annular in shape (when viewed cross-sectionally) in the illustrated embodiment, they may have other shapes in other embodiments. For example, the exterior or interior (or both) cross-sections of the supply lumen member 181 and the distribution lumen member 182 may be shaped as an ellipse, triangle, square, rectangle, or other polyhedral shape or shape having any linear or arcuate portions, or any combination of such shapes. Further, the distribution lumen member 182 may be attached to the hand enclosure 121 or the hand liner 122, or both, along part or all of their respective lengths. In such cases, the distribution lumen member 182 may be connected using any suitable means, such as welding (ultra sound and radio frequency welding), fusing (including heat sealing), adhesives, glues, epoxies, clasps, clamps, clips, agent bonding, or combinations of such means. Alternatively, portions of the distribution lumen member 182 may not be connected to any portion of the hand casing 120. In still other embodiments, the distribution lumen member 182 may be located in whole or in part on the interior surface or exterior surface of the hand enclosure 121. If it is located on the exterior surface of the hand enclosure 121, the perforations 183 may penetrate the wall of the hand enclosure 121 to provide fluid communication between the volume within the hand enclosure 121 and the distribution lumen member 182. In other embodiments, the distribution lumen member 182 may be located in whole or in part on the interior surface (the surface facing the body of the user) or exterior surface of the hand liner 122. If they are located on the exterior surface of the hand liner 122, the perforations 183 may penetrate the wall of the hand liner 122 to provide fluid communication between the volume within the hand enclosure 121 and the distribution lumen member 182. In still other embodiments, the distribution lumen member 182 may be embedded in whole or in part within the hand enclosure 121 or the hand liner 122. In such cases, the distribution lumen member 182 may be fabricated as a single piece with the hand enclosure 121 or the hand liner 122, respectively. Alternatively, the embedded distribution lumen member 182 may be created by forming channels or grooves in one piece (such as a sheet) of material that will comprise the hand enclosure 121 or the hand liner 122 and then attaching another piece (such as a sheet) of material to the first piece, wherein the other piece has perforations 183 therein that will be positioned over the channels or grooves.

In the embodiment of the present invention illustrated in FIG. 2B, the apparatus 110 is further comprised of a control unit 160. A schematic view of an embodiment of the control unit 160 is illustrated in FIG. 2D. In the embodiment of the control unit 160 illustrated in FIG. 2D, the control unit 160 is comprised of a negative pressure supply source (a portable vacuum pump 161), a vacuum control device 162 to control the operation of the vacuum pump 161, an alarm 163, a radio frequency transceiver 164, a filter 165, a lumen control device 166, a GPS receiver 167, a processor 168, and a power source 169. In the embodiment illustrated in FIG. 2D, the negative pressure supply source, which produces a source of negative pressure or suction that is supplied to the hand enclosure 121 by means of the negative pressure supply means 170, is comprised of a portable vacuum pump 161 that is positioned within the housing of the control unit 160. Although this is the preferred means of producing the reduced pressure or suction, in other embodiments other means may be used, such as a non-portable vacuum pump positioned separate from the control unit 160 or an outlet port of a centralized vacuum system. In the illustrated embodiment, predetermined amounts of suction or negative pressure are produced by the vacuum pump 161. The vacuum pump 161 is connected to the negative pressure supply means 170 in order to supply suction to the hand enclosure 121. The vacuum pump 161 is vented to the ambient atmosphere or an enclosed volume, such as a sealed container, where it is desirable that venting not occur to the ambient atmosphere. The vacuum pump 161 is preferably controlled by the control device 162, such as a switch or rheostat, which regulates the operation of the vacuum pump 161. The vacuum control device 162 is preferably activated and controlled by the processor 168 in the illustrated embodiment, as described in more detail below. In other embodiments, a timer, sensor or other means may activate or control the vacuum control device 162. The vacuum control device 162 may provide cyclic on/off operation of the vacuum pump 161 according to user-selected intervals. Alternatively, the vacuum pump 161 may be operated continuously without cyclical operation. In addition, in some embodiments the vacuum control device 162 may provide for separate control of the level of negative pressure applied to the volume within the hand enclosure 121 and the flow rate of fluid (such as perspiration), if any, removed from the portion of the body enclosed by the hand enclosure 121. In these embodiments, relatively low levels of negative pressure may be maintained at the portion of the body enclosed by the hand enclosure 121, while still providing for the removal of a relatively large volume of fluid from such portion of the body. A filter 165, such as a micro-pore filter or antimicrobial filter (or both), is preferably positioned within the housing for the control unit 160. The filter 165 is operably connected between the inlet of the vacuum pump 161 and the negative pressure supply means 170. The filter 165 prevents potentially pathogenic microbes or aerosols from contaminating, and then being vented to atmosphere by, the vacuum pump 161. In other embodiments, the filter 165 may also be a hydrophobic filter that prevents any fluids received from the hand enclosure 121 from contaminating, and then being vented to atmosphere by, the vacuum pump 161. It is to be noted that in other embodiments of the invention, the control unit 160 may not have a filter 165 or a vacuum control device 162 or any combination of the same.

In the embodiment of the control unit 160 illustrated in FIG. 2D, the lumen control device 166 may be used in conjunction with the lumen system 180 to provide fluids to or remove fluids from the hand casing 120. Preferably, the components comprising the lumen control device 166 are positioned within the housing for the control unit 160, but the various components of the lumen control device 166 need not be so positioned in every embodiment of the control unit 160. It is to be noted that although the lumen control device 166 and the lumen system 180 may be used to remove fluids from the hand casing 120 in some embodiments, it is preferred that fluids be removed from the hand casing 120 by means of the vacuum pump 161 and the negative pressure supply means 170. Thus, as illustrated in FIG. 2D, the lumen control device 166 is preferably comprised of a lumen pump 166a, a lumen controller 166b that regulates the operation of the lumen pump 166a, and a lumen source 166c that acts as a source of the fluid to be provided through the lumen control device 166 and the lumen system 180 to the hand casing 120. In the illustrated embodiment, a predetermined range of flow rates of fluid may be produced by the lumen pump 166a, which is preferably a portable, self-priming pump. The preferred type of pump to be used as the lumen pump 166a depends upon the type of fluid, the flow rate of the fluid, and other parameters. The inlet of the lumen pump 166a is operably connected to the lumen source 166c, which may be container or tank (not illustrated) used to store the fluid utilized by the lumen control device 166. The container or tank may be positioned within or on the housing of the control unit 160, which is preferred, or it may be positioned in another location. Where the tank or container is under pressure, a regulator (not illustrated) may be used to reduce the pressure of the fluid as it leaves the tank or container. Alternatively, fluid may be drawn from the ambient environment through a filter (not illustrated) in substantially the same manner as is the case for the lumen system 80 described below and illustrated in connection with FIG. 1A. The outlet of the lumen pump 166a is operably connected to the lumen system 180. The lumen pump 166a is preferably controlled by the lumen controller 166b, which is a switch, rheostat or similar device that may be used to regulate the operation of the lumen pump 166a. The lumen controller 166b is activated and controlled by the processor 168 in the illustrated embodiment, as described in more detail below. In other embodiments, a timer, sensor or other means may activate or control the lumen controller 166b. The lumen controller 166b may provide cyclic on/off or intermittent operation of the lumen pump 166a according to user-selected or parameter-dependent intervals. Alternatively, the lumen pump 166a may be operated continuously without cyclical operation. In addition, in some embodiments the lumen controller device 166b may provide for separate control of the level of pressure applied to the volume within the hand enclosure 121 and the flow rate of fluid provided to the hand enclosure 121. A filter (not illustrated) or a valve or other means (not illustrated) to prevent backflow of fluid, or both, may be operably positioned within the lumen system 180. It is to be noted that in other embodiments of the invention, the control unit 160 may not have a lumen control device 166 or various components comprising the lumen control device 166.

In the embodiment of the control unit 160 illustrated in FIG. 2D, the power source 169 is also contained within or on the housing for the control unit 160, which is the preferred embodiment. In other embodiments, the power source 169 may be positioned remote from the housing for the control unit 160. The power source 169 may be any source of energy currently known in the art or that may be developed in the art in the future that may be used to power the portable vacuum pump 161 and the other components comprising the control unit 160. For example, in the preferred embodiment, the power source 169 may be a rechargeable fuel cell or battery. Alternatively, the power source 169 may be a standard electrical outlet (not illustrated), which may be connected to the control unit 160 by means of appropriate conducting means, such as insulated copper wires (not illustrated). In the illustrated embodiment, the radio frequency transceiver 164 is preferably positioned within the housing for the control unit 160. The radio frequency transceiver 164 need not, however, be positioned within such housing in all embodiments of the control unit 160. The radio frequency transceiver 164 may be used to receive data, commands and other information from the processor 168 and transmit such data, commands and other information to a remote radio frequency receiver (not illustrated). Similarly, the radio frequency transceiver 164 may receive data, commands and other information from a remote radio frequency transmitter (not illustrated) and transmit such data, commands and other information to the processor 168. Thus, a person remote from the apparatus 110 may monitor the operation of the apparatus 110 or provide control input to the apparatus 110 or both. The alarm 163 is also preferably positioned within or on the housing of the control unit 160, but may be positioned in other locations, such as within the head casing 40 where the embodiment of the present invention described herein and illustrated in connection with FIG. 1A is used with a control unit 60 similar to the control unit 160 of the embodiment illustrated in FIG. 2D. The alarm 163 is preferably connected to the processor 168, but may be connected to other components of the control unit 160, such as the vacuum control device 162 or the lumen control device 166. The alarm 163 may be an audible alarm, a light source that produces a steady or intermittent light, a vibrating alarm, or any other type of alarm currently known in the art or that may be developed in the art in the future, or combinations of such alarms. Generally, the alarm 163 is activated when a designated parameter related to the operation of the apparatus 110 exceeds or falls below a pre-selected value. For example, an audio alarm comprising the alarm 163 may sound if the negative pressure within the hand enclosure 121 falls below a given value or if the moisture level in the hand enclosure 121 exceeds a given value. In the illustrated embodiment, the GPS receiver 167 is preferably positioned within the housing for the control unit 160. The GPS receiver 167 need not, however, be positioned within such housing in all embodiments of the control unit 160. The GPS receiver 167 may be used to receive data from and transmit data to global positioning system satellites so that the geographic position of the apparatus 110 may be pinpointed. It is to be noted that in other embodiments of the control unit 160, the various components comprising the control unit 160 described above may or may not be present.

The processor 168 is the primary center of control and monitoring for the apparatus 110. The processor 168 is generally comprised of one or more integrated circuits, electronic circuit boards, or other electronic components, or combinations of such integrated circuits, circuit boards, and components. As such, the processor 168 may receive data, commands and information from the at least one sensor member 123 via the electronic communication system 125 and may process, convert, store, transmit or otherwise process such data, commands and information. Such data, commands and information may be sent to the processor 168 on various bases, such as continuously, at regular intervals, at irregular intervals, or upon the occurrence of specific events. For example, the at least one sensor member 123 may send a signal to the processor 168 regarding the level of negative pressure within the hand enclosure 121 at predetermined intervals, such as every 15 seconds. The processor 168 may store this information for later uploading to a computer (not illustrated) or may transmit it via the radio frequency transceiver 164 to a remote radio frequency receiver (not illustrated) for use in remote monitoring of the operation of the apparatus 110. Alternatively, the at least one sensor member 123 may send a command to the processor 168 requesting more suction at any time that the level of negative pressure within the hand enclosure 121 drops below a predetermined value. In this case, the processor 168 will send a signal to the vacuum control device 162 to increase the vacuum produced by the vacuum pump 161 until such time as the negative pressure level returns to normal, as indicated by a subsequent pressure signal regularly transmitted by the at least one sensor member 123. Data, information and commands of this type may be received by the processor 168 from the at least one sensor member 123 with respect to any measured parameter. Where commands are received from the at least one sensor member 123 by the processor 168 related to such parameters, the processor 168 transmits the command to the appropriate component of the control unit 160 to execute the command. For example, if the at least one sensor 123 sends a signal that indicates the pH of fluid provided through the lumen system 180, as it currently exists in the hand enclosure 121, falls below a predetermined value, the processor 168 may send a command to the lumen control device 166 to increase the flow of such fluid or a different fluid to the hand enclosure 121. The processor 168 may also monitor such parameters, and perform calculations involving such parameters, in order to record the results of such calculations or to issue necessary commands or both. For example, the processor 168 may calculate the difference between successive signals indicating the negative pressure level within the hand enclosure 121 and if the difference between any two successive signals is more than a predetermined value, the processor 168 may transmit a command to activate the alarm 123. Conversely, the processor 168 may send data, commands and other information to the at least one sensor member 123 or other components comprising the control unit 160 or both. In such cases, another processor (not illustrated) that is a part of the at least one sensor member 123 may receive and use such data and information for predetermined purposes or implement a command received from the processor 168, such as to close a valve (not illustrated) in the reduced pressure distribution means 124. It may also be desirable to have input means 168a available as a part of the control unit 160, so that the user may provide input into the control unit 160. Such input means 168a may be comprised of switches, buttons, voice activated command modules, or other input means or combinations of such means currently known in the relevant art or that may be developed in the relevant art in the future. The preferred input means 168a depends upon the information to be input, the preference of the user of the appliance 110, and other factors. In addition, it may be desirable to have output means 168b available as a part of the control unit 160 to provide a means to display certain information. For example, such output means 168b may be comprised of light bars, gauges, chart recorders, or other output means or combinations of such means currently known in the relevant art or that may be developed in the relevant art in the future. It is to be noted that the processor 168 may have different functions, features and components (including input means 168a and output means 168b) in different embodiments of the control unit 160. The preferred functions, features and components depend upon the nature of the environment, the anticipated uses of the apparatus 110, the components comprising the apparatus 110 (such as a lumen system 180), the operating parameters and conditions of the apparatus 110, and other factors.

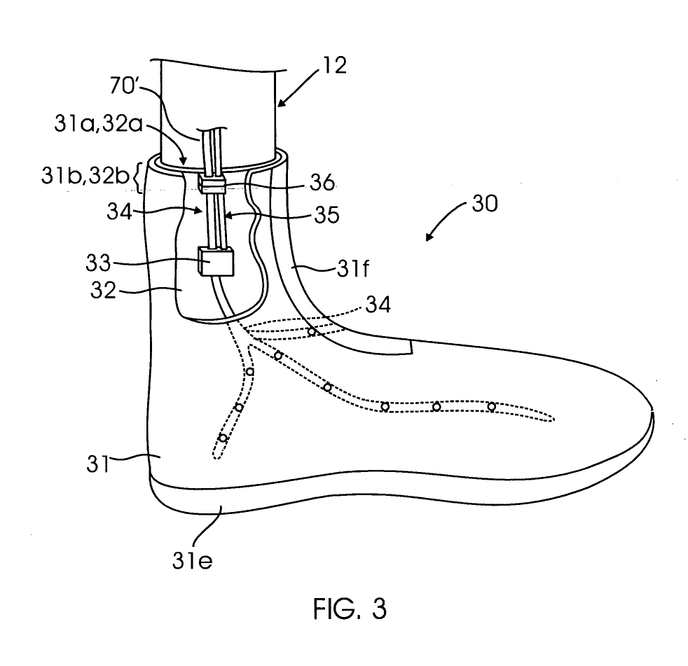

An enlarged, partially broken away perspective view of an embodiment of a foot casing 30 is illustrated in FIG. 3. In this embodiment, the foot casing 30 is generally comprised of an extremity enclosure in the approximate shape of a foot, ankle and sometimes a portion of the leg 12 (foot enclosure 31), a liner in the approximate shape of a foot, ankle and sometimes a portion of the leg 12 (foot liner 32), at least one sensor member 33, negative pressure distribution means 34, electronic communication means 35, a casing connector 36, and extremity enclosure sealing means and negative pressure supply means 70′, both of which are described in more detail below. It is to be noted that the foot casing 30 may be used as a part of the apparatus 10 illustrated in FIG. 1A, or other embodiments of the apparatus 10. In such cases, the foot casing 30 may be removably or permanently sealed to the partial body casing 50, as briefly described above in connection with FIG. 1A, and as described in more detail below, using the body/extremity sealing means. Alternatively, the foot casing 30 may be used alone with a separate control unit (not illustrated). For example, a person may place the foot casing 30 on his or her foot, ankle and portion of the leg 12 to perform functions in an area that may have hazardous material on the floor in such area. In this case, the portion 31b of the foot enclosure 31 approximately adjacent to the opening 31a of the foot enclosure 31 may be sealed to the portion of the person's leg 12 approximately adjacent to the opening 31a of the foot enclosure 31 using extremity enclosure sealing means, which are described in more detail herein. Alternatively, the portion 31b of the foot enclosure 31 approximately adjacent to the opening 31a of the foot enclosure 31 may be sealed to the portion 32b of the foot liner 32 approximately adjacent to the opening 32a of the foot liner 32, which is then sealed to the portion of the person's leg 12 approximately adjacent to the opening 32a of the foot liner 32 using extremity enclosure sealing means, which are described in more detail below. The extremity enclosure sealing means provides a fluid-tight seal, so that negative pressure may be maintained in the volume within the foot casing 30. The extremity enclosure sealing means may or may not be utilized in embodiments where the foot casing 30 is used with the apparatus 10 illustrated in FIG. 1A, or other embodiments of the apparatus 10. As yet another alternative, the foot casing 30 may be used in connection with other applications. For example, the foot casing 30 may be used in conjunction with conventional protective suits. In some embodiments, the foot casing 30 may extend to cover the foot, ankle and any portion of the leg 12 of the user of the foot casing 30, such as the foot, ankle and leg 12 up to the torso.

Referring again to FIG. 3, the foot enclosure 31 is generally sized to be placed over and enclose the foot, ankle (and possibly a portion of the leg 12) of the user of the foot casing 30.

The foot enclosure 31 and the extremity enclosure sealing means (described in more detail below) allow negative pressure to be maintained in the volume within the foot enclosure 31 at the foot, ankle and portion of the leg 12 covered by the foot enclosure 31. The negative pressure supply means 70′ (described in more detail below) are used to operably connect the negative pressure distribution means 34 of the foot casing 30 to a control unit, which is not illustrated in FIG. 3, but which may be the control unit 60 in embodiments where the foot casing 30 is used as a part of the apparatus 10 described herein in connection with and illustrated in FIG. 1A (or other embodiments or aspects of the apparatus 10). The control unit generally includes a negative pressure supply source (also not illustrated), which provides a supply of negative pressure to the foot casing 30, so that the volume within the foot enclosure 31 at the foot, ankle and portion of the leg 12 covered by the foot enclosure 31 may be maintained at negative pressure. In the various embodiments of the foot casing 30, the foot enclosure 31 may be comprised of substantially the same types of materials, the same combinations of materials, the same thicknesses or variations in thicknesses of materials, the same types of folds, channels and panels (none of which are illustrated in FIG. 3), the same types of variation in rigidity, and other features, characteristics and operation that may be used to comprise or that characterize any of the embodiments of the hand enclosure 21, as described above and illustrated in connection with FIG. 2A. The preferred wall thickness of the foot enclosure 31 is dependent upon the size of the foot enclosure 31, the magnitude of the reduced pressure to be maintained under the foot enclosure 31, the degree of dexterity desired in performing tasks using the foot casing 30, the materials and other conditions present in the ambient environment, the materials comprising the foot enclosure 31, and the individual preferences of the user of the foot casing 30. For example, for a foot enclosure 31 constructed entirely of polyurethane, TYVEK or LATEX, sized to fit a standard adult male foot, being of a uniform thickness, for performing hazardous material remediation work on a concrete floor in an ambient environment having a temperature in the range of 45 to 95 degrees F., the preferred thickness of the foot enclosure 31 is in the range from 0.02 inches to 0.1 inches. It is to be noted that in other embodiments the thickness of the foot enclosure 31, including any rigid or semi-rigid portions of the foot enclosure 31, may vary from embodiment to embodiment, as well as from location to location on the foot enclosure 31. In addition, the foot enclosure 31 may also have a sole portion 31e positioned at the base of the foot enclosure 31. The sole portion 31e of the foot enclosure 31 may be comprised of a more rigid material, which may generally be any type of material that is used to construct the sole of shoes or boots. Preferably, the sole portion 31e of the foot enclosure 31 is constructed of rubber (including neoprene) or another material more impervious to the hazardous materials in the environment that has similar structural characteristics, in each case preferably having a thickness in the range from 0.1 inches to 0.5 inches. In various embodiments, as illustrated in FIG. 3, the foot enclosure 31 may also be comprised of means to assist the user in putting the foot casing 30 on his or her foot and removing the foot casing 30 from his or her foot. In the illustrated embodiment, such means is comprised of a fluid-tight zipper seal 31f. Such zipper seals 31f are well known in the art. In other embodiments, other types of fluid-tight seals may be used, such as those utilizing hook and loop fasteners (such as VELCRO).

In the illustrated embodiment, the foot casing 30 is also comprised of a foot liner 32. It is to be noted that the foot liner 32 may be used, and is preferably used, with the foot casing 30. In other embodiments, however, the foot casing 30 may be used without the foot liner 32. The foot liner 32 serves to protect the skin of the user that is adjacent to the foot casing 30 in some embodiments. In other embodiments, the foot liner 32 serves to prevent fluids emitted from the portion of the body adjacent to the foot casing 30 from reaching the volume between the foot liner 32 and the foot enclosure 31, so that such fluid does not activate the sensor member 33, such as humidity detection means that may be a part of the sensor member 33. Where the foot liner 32 is utilized, the foot enclosure 31 may be sealed to the foot liner 32, which may then be sealed to the portion of the person's leg 12 approximately adjacent to the opening 32a of the foot liner 32 using the extremity enclosure sealing means, which are described in more detail herein. The extremity enclosure sealing means provide a fluid-tight seal, so that negative pressure may be maintained in the volume within the foot casing 30. The foot enclosure 31 may also generally be sealed to the foot liner 32 using the extremity enclosure sealing means described in more detail herein. Alternatively, the foot enclosure 31 may be sealed to the foot liner 32 using any other suitable type of fluid-tight seal, which may also be considered extremity enclosure sealing means. For example, the foot enclosure 31 may be sealed to the foot liner 32 by means of welding (including ultra sound and radio frequency welding), fusing (heat sealing), adhesives, glues, epoxies, agent bonding, or combinations of such means. As is the case with the foot enclosure 31, the foot liner 32 is generally sized to be placed over and enclose the foot, ankle and a portion of the leg 12 of the user of the foot casing 30. Although the foot liner 32 preferably extends the same distance along the ankle and leg 12 as the foot enclosure 31, as illustrated in FIG. 3, the foot liner 32 may extend further along the leg 12 than the foot enclosure 31, or it may not extend as far along the leg 12 as the foot enclosure 31. In the various embodiments of the foot casing 30, the foot liner 32 may be comprised of substantially the same materials that may be used for the hand liner 22, as described above and illustrated in connection with FIG. 2A. The preferred thickness of the foot liner 32 is dependent upon the size and thickness of the foot enclosure 31, the magnitude of the negative pressure to be maintained under the foot enclosure 31, the degree of dexterity desired in performing tasks using the foot casing 30, the materials and other conditions present in the ambient environment, the materials comprising the foot liner 32 and the foot enclosure 31, and the individual preferences of the user of the foot casing 30. More preferred in this embodiment, the foot liner 32 is comprised of LATEX having a layer of cotton-polyester blend, and the wall thickness of the foot liner 32 is in the range from 0.02 inches to 0.1 inches.

The foot enclosure 31, or the foot liner 32 in some embodiments, of the foot casing 30 may be sealed to the portion of the user's leg 12 approximately adjacent to the opening 31a, 32a of the foot enclosure 31 or foot liner 32, respectively, by the extremity enclosure sealing means. In the embodiment illustrated in FIG. 3, the extremity enclosure sealing means, as well as the methodology that may be used in sealing the openings 31a, 32a of the foot enclosure 31 and foot liner 32, may be any of the extremity enclosure sealing means and methodologies that may be used in connection with any of the embodiments of the hand casing 20, as described above and illustrated in connection with FIG. 2A. As is also illustrated in FIG. 3, the foot casing 30 is also comprised of negative pressure distribution means 34, which assists in the distribution of negative pressure received from the negative pressure supply source by means of the negative pressure supply means 70′ throughout all or a portion of the volume within the foot enclosure 31. In the illustrated embodiment, the negative pressure distribution means 34 may generally have substantially the same type of structure, features, characteristics and operation as any of the embodiments of the negative pressure distribution means 24 that may be used in connection with the hand casing 20, as described above and illustrated in connection with FIG. 2A. In the embodiment of the present invention illustrated in FIG. 3, the foot casing 30 is further comprised of electronic communication means 35. The electronic communication means 35 generally connects a control unit (not illustrated, but which may be the control unit 60 described herein and illustrated in connection with FIG. 1A in some embodiments of the present invention) to the sensor member 33. In various embodiments, the electronic communication means 35 may generally have substantially the same type of structure, features, characteristics and operation as any of the embodiments of the electronic communications system 25 that may be used in connection with the hand casing 20, as described above and illustrated in connection with FIG. 2A. In the embodiment of the present invention illustrated in FIG. 3, the foot casing 30 is further comprised of a casing connector 36. In various embodiments, the casing connector 36 may generally have substantially the same type of structure, features, characteristics and operation as any of the embodiments of the casing connectors 26, 126 that may be used in connection with the hand casings 20, 120, respectively, as described above and illustrated in connection with FIG. 2A and FIG. 2B. In the illustrated embodiment, the foot casing 30 is also comprised of a sensor member 33, which is generally operably connected to the control unit by the electronic communication means 34, so that the sensor member 33 is in electronic communication with the control unit. In various embodiments, the sensor member 33 may generally have substantially the same type of structure, features, characteristics and operation as any of the embodiments of the sensor member 23 that may be used in connection with the hand casing 20, as described above and illustrated in connection with FIG. 2A. In addition, in the illustrated embodiment, the foot casing 30 is further comprised of negative pressure supply means 70′, which are used to connect the negative pressure supply source (which is typically a part of the control unit and is not illustrated) to the foot casing 30 in a manner so that negative pressure is supplied to the volume within the foot enclosure 31 at the portion of the user's foot, ankle and leg 12 that are covered by the foot enclosure 31, as described in more detail herein. In various embodiments, the negative pressure supply means 70′ may generally have substantially the same type of structure, features, characteristics and operation as any of the embodiments of the negative pressure supply means 70 that may be used in connection with the hand casing 20, as described above and illustrated in connection with FIG. 2A. Further, even though it is not included as a part of the foot casing 30 illustrated in FIG. 3, in some embodiments the foot casing 30 may also be comprised of a lumen system. In such embodiments, the lumen system may generally have substantially the same type of structure, features, characteristics and operation as any of the embodiments of the lumen system 180 that may be used in connection with the hand casing 120, as described above and illustrated in connection with FIG. 2B. Further still, the foot casing 30 may also comprise a control unit (not illustrated). In such embodiments, the control unit may generally have substantially the same type of structure, features, characteristics and operation as any of the embodiments of the control unit 160 that may be used in connection with the hand casing 120, as described above and illustrated in connection with FIG. 2B.

Referring again to FIG. 1A, the apparatus 10 is comprised of a partial body casing 50, which is permanently or removably sealed to the hand casings 20 and the foot casings 30 using body/extremity sealing means, which are described in more detail below. In the illustrated embodiment, the partial body casing 50 is generally comprised of a partial body enclosure 51 in the approximate shape of a torso, arms, legs, and neck, a partial body 52 liner in the approximate shape of a torso, arms, legs, and neck, at least one body sensor 53 (illustrated schematically), negative pressure distribution means 54, electronic communication means 55, a lumen system 80, and extremity enclosure sealing means, which are described in more detail herein. It is to be noted that the partial body casing 50 may be used with or without either or both of the hand casings 20, with or without either or both of the foot casings 30, and with or without the head casing 40. In cases involving use of the hand casings 20 and the foot casings 30, the hand casings 20 and the foot casings 30 may be removably or permanently sealed to the partial body casing 50 using the body/extremity sealing means (described in more detail below). In cases involving use of the head casing 40, the partial body casing 50 may be removably or permanently sealed to the head casing 40 using the body/head sealing means (described in more detail below). Alternatively, the partial body casing 50 may be used in connection with other applications. For example, the partial body casing 50 may be used in conjunction with hand, foot and head members utilized in conventional protective suits.

Referring again to FIG. 1A, the partial body enclosure 51 is generally sized to be placed over and enclose the torso and a portion of the arms, legs and neck of the user of the partial body casing 50. The partial body enclosure 51 and the body/extremity sealing means and body/head sealing means (both described in more detail below) allow negative pressure to be maintained in the volume within the partial body enclosure 51 at the portion of the body covered by the partial body enclosure 51. The negative pressure distribution means 54 of the partial body casing 50 is connected to the control unit 60. The control unit 60 generally includes a negative pressure supply source (not illustrated), which provides a supply of negative pressure to the partial body casing 50 by means of the negative pressure distribution means 54, so that the volume within the partial body enclosure 51 at the portion of the body covered by the partial body enclosure 51 may be maintained at negative pressure. In the various embodiments of the partial body casing 50, the partial body enclosure 51 may be comprised of substantially the same types of materials, the same combinations of materials, the same thicknesses or variations in thicknesses of materials, the same types of folds, channels and panels (none of which are illustrated in FIG. 1A), the same types of variation in rigidity, and other features, characteristics and operation that may be used to comprise or that characterize any of the embodiments of the hand enclosure 21 and foot enclosure 31, as described above and illustrated in connection with FIG. 2A and FIG. 3, respectively. The preferred wall thickness of the partial body enclosure 51 is dependent upon the size of the partial body enclosure 51, the magnitude of the reduced pressure to be maintained under the partial body enclosure 51, the degree of dexterity desired in performing tasks using the partial body casing 50, the materials and other conditions present in the ambient environment, the materials comprising the partial body enclosure 51, and the individual preferences of the user of the partial body casing 50. For example, for a partial body enclosure 51 constructed entirely of polyurethane, TYVEK, nylon, polyester, or LATEX, sized to fit a standard adult male, being of a uniform thickness, for performing hazardous material remediation work in an ambient environment having a temperature in the range from 45 to 95 degrees F., the preferred thickness of the partial body enclosure 51 is in the range from 0.02 inches to 0.1 inches. It is to be noted that in other embodiments the thickness of the partial body enclosure 51, including any rigid or semi-rigid portions of the partial body enclosure 51, may vary from embodiment to embodiment, as well as from location to location on the partial body enclosure 51. In addition, the partial body enclosure 51 may also be comprised of means to assist the user in putting the partial body casing 50 on his or her body and removing the partial body casing 50 from his or her body. In the illustrated embodiment, such means may be comprised of a fluid-tight zipper seal (not illustrated) that extends along the back of the partial body enclosure 51 from the opening 51a at the neck of the partial body enclosure 51 to the lower back portion of the partial body enclosure 51. Such zipper seals are well known in the relevant art. In other embodiments, other types of fluid-tight seals may be used, such as those utilizing hook and loop fasteners (such as VELCRO).

In the illustrated embodiment, the partial body casing 50 is also comprised of a partial body liner 52. It is to be noted that the partial body liner 52 may be used, and is preferably used, with the partial body casing 50. In other embodiments, however, the partial body casing 50 may be used without the partial body liner 52. The partial body liner 52 serves to protect the skin of the user that is adjacent to the partial body casing 50 in some embodiments. In other embodiments, the partial body liner 52 serves to prevent fluids emitted from the portion of the body adjacent to the partial body casing 50 from reaching the volume between the partial body liner 52 and the partial body enclosure 51, so that such fluid does not activate the at least one sensor member 53, such as humidity detection means that may be a part of the sensor member 53. Where the partial body liner 52 is utilized without a hand casing 20, a foot casing 30, or a head casing 40, the partial body enclosure 51 may be sealed to the partial body liner 52, which may then be sealed to the portion of the person's body approximately adjacent to the corresponding opening 52a′, 52a″, 52a, respectively, of the partial body liner 52 using substantially the same extremity enclosure sealing means that may be used with any embodiments of the hand casing 20 or the foot casing 30, as described above and illustrated in connection with FIG. 2A and FIG. 3, respectively. The extremity enclosure sealing means provides a fluid-tight seal, so that negative pressure may be maintained in the volume within the partial body casing 50. The partial body enclosure 51 may also generally be sealed to the partial body liner 52 using the extremity enclosure sealing means described in more detail herein. Alternatively, the partial body enclosure 51 may be sealed to the partial body liner 52 using any other suitable type of fluid-tight seal, which may also be considered extremity enclosure sealing means. For example, the partial body enclosure 51 may be sealed to the partial body liner 52 by means of welding (including ultra sound and radio frequency welding), fusing (including heat sealing), adhesives, glues, epoxies, agent bonding, or combinations of such means. In yet other alternatives, the partial body enclosure 51 may not be sealed to the partial body liner 52 at all. As is the case with the partial body enclosure 51, the partial body liner 52 is generally sized to be placed over and enclose the torso and a portion of the arms, legs and neck of the user of the partial body casing 50. Although the partial body liner 52 preferably extends the same distance along the arms, legs, and neck as the partial body enclosure 51, as illustrated in FIG. 1A, the partial body liner 52 may extend further along the arms, legs or neck than the partial body enclosure 51, or it may not extend as far along the arms, legs or neck, respectively, as the partial body enclosure 51. In some embodiments of the partial body casing 50, the partial body liner 52 may be comprised of substantially the same materials that may be used for the hand liner 22 or the foot liner 32, as described above and illustrated in connection with FIG. 2A and FIG. 3, respectively. In other embodiments, the partial body liner 52 may be constructed of other materials. For example, the partial body liner 52 may also be comprised of naturally occurring or synthetic fibers, fabrics or materials, such as cotton, polyester, nylon, and rayon, or any combination of all such fibers, fabrics and materials. In yet other embodiments, the partial body liner 52 may be comprised of the user's ordinary street clothes. Preferably, the partial body liner 52 is constructed of a cotton-polyester blend with a layer of LATEX deposed on the surface thereof that is opposite the surface facing the body. Preferably, the partial body liner 52 also has means to assist the user of the apparatus 10 in putting on and taking off the partial body liner 52, such as the fluid-tight zipper means described above in connection with FIG. 1A. In addition, the partial body liner 52 is preferably not as thick as the partial body enclosure 51. The preferred thickness of the partial body liner 52 is dependent upon the size and thickness of the partial body enclosure 51, the magnitude of the negative pressure to be maintained under the partial body enclosure 51, the degree of dexterity desired in performing tasks using the partial body casing 50, the materials and other conditions present in the ambient environment, the materials comprising the partial body liner 52 and the partial body enclosure 51, and the individual preferences of the user of the partial body casing 50. More preferred in this embodiment, for a partial body liner 52 comprised of a cotton-polyester blend with a layer of LATEX, the wall thickness of the partial body liner 52 is in the range from 0.02 inches to 0.1 inches.

In some embodiments (such as where the apparatus 10 does not utilize a hand casing 20, a foot casing 30, or a head casing 40), the partial body enclosure 51, or the partial body liner 52 in some embodiments, of the partial body casing 50 may be sealed to the portion of the user's neck, arms and legs approximately adjacent to the opening 51a, 51a′, 51a″, 52a, 52a′, 52a″ of the partial body enclosure 51 or partial body liner 52, respectively, by the extremity enclosure sealing means. In the embodiment illustrated in FIG. 1A, the extremity enclosure sealing means, as well as the methodology that may be used in sealing the openings 51a, 51a′, 51a″, 52a, 52a′, 52a″ of the partial body enclosure 51 or partial body liner 52, may be any of the extremity enclosure sealing means and methodologies that may be used in connection with any of the embodiments of the hand casing 20 or the foot casing 30, as described above and illustrated in connection with FIG. 2A and FIG. 3, respectively. In embodiments where the apparatus 10 utilizes a hand casing 20 or a foot casing 30, the partial body enclosure 51, or the partial body liner 52 in some embodiments, of the partial body casing 50 may be sealed to the portion 21b, 22b, 31b, 32b of the hand casing 20 and the foot casing 30, respectively, using the body/extremity sealing means. In some embodiments, the body/extremity sealing means may be substantially the same as the extremity enclosure sealing means. In other embodiments, the body/extremity sealing means may be any other suitable type of fluid-tight seal. For example, the partial body enclosure 51 may be permanently sealed to the hand casing 20 or the foot casing 30 by means of welding (including ultra sound and radio frequency welding), fusing (including heat sealing), adhesives, glues, epoxies, agent bonding, ultra violet, or combinations of such means. In other embodiments, as illustrated in FIG. 1A, the interior surface portion of the partial body enclosure 51 adjacent to the perimeter of the openings 51a′, 51a″ of the partial body enclosure 51 overlap, are positioned around, and may be held against a portion 21b or 31b of a hand enclosure 21 or a foot enclosure 31, respectively. Negative pressure may then be supplied to the apparatus 10 by means of the negative pressure supply source that is a part of the control unit 60. When negative pressure is applied to the volume within the apparatus 10, the partial body enclosure 51 is drawn downward by the negative pressure, collapsing the partial body enclosure 51 in the approximate direction of the portion 21b or 31b of the hand enclosure 21 or the foot enclosure 31, respectively, that is adjacent to the partial body enclosure 51. As the partial body enclosure 51 collapses, it is drawn tightly against the adjacent portion 21b or 31b of the hand enclosure 21 or the foot enclosure 31, respectively, thus forming a fluid-tight seal between the partial body enclosure 51 and the hand enclosure 21 and the foot enclosure 31. In some embodiments, it may be necessary to provide other body/extremity sealing means (not illustrated) to provide a fluid-tight seal between the portions 21b, 31b of the hand enclosure 21 or foot enclosure 31, respectively, and the partial body enclosure 51. For example, the body/extremity sealing means may also be comprised of lanoline, a hydrocolloid material, hook and loop fasteners (such as VELCRO), snaps, clamps, clips, or a stretch fabric that is wrapped around a portion of the body of the user that covers portions of the partial body enclosure 51, the hand enclosure 21, or the foot enclosure 31, or any combination of such means. It is to be noted that in some embodiments, the portions 21b or 31b of the hand enclosures 21 or foot enclosures 31, respectively, may be placed over the adjacent portions of the partial body enclosure 51, rather than the partial body enclosure 51 being placed over the portions 21b or 31b of the hand enclosures 21 or foot enclosures 31, respectively. In such cases, the same body/extremity sealing means may be used to seal the partial body casing 50 to the hand enclosures 21 or foot enclosures 31.

As is also illustrated in FIG. 1A, the partial body casing 50 is also comprised of negative pressure distribution means 54, which assists in the distribution of negative pressure received from the negative pressure supply source of the control unit 60 throughout all or a portion of the volume within the partial body enclosure 51. In the illustrated embodiment, the negative pressure distribution means 54 may generally have substantially the same type of structure, features, characteristics and operation as any of the embodiments of the negative pressure distribution means 24 or 34 that may be used in connection with the hand casing 20 or foot casing 30, respectively, as described above and illustrated in connection with FIG. 2A and FIG. 3, respectively. Thus, the negative pressure distribution means 54 may be generally comprised of a system of tubing members, such as tubing members 54a, 54b, that distribute negative pressure throughout the whole or partial volume within the partial body casing 50. The negative pressure distribution means 54 may also be comprised of a series of perforations (not illustrated) to assist in accomplishing this purpose. In various embodiments, all or a portion of the negative pressure distribution means 54 may be attached to the partial body enclosure 51 or partial body liner 52 or both, or may be embedded in the partial body enclosure 51 or partial body liner 52 or both. It is to be noted that the negative pressure distribution means 54 may also act as the reduced pressure supply means 70, 70′ for the hand casing 20 and the foot casing 30, respectively. For example, the tubing member 54a may also act as the tubing member 71, so that the end of the tubing member 54a, 71 is connected to the casing connector 26, as described above and illustrated in connection with FIG. 2A. In other embodiments, the negative pressure supply means 54 may be a separate means, such as a designated tubing member (not illustrated), that is connected to the control unit 60 at one end and to the casing connector 26 at the other end, as described above and illustrated in connection with FIG. 2A. In either case, the two connector members 26a, 26b of the casing connector 26 (as illustrated in FIG. 2A and FIG. 2C) are removably connected together prior to sealing the hand casing 20 to the partial body casing 50.

In the embodiment of the present invention illustrated in FIG. 1A, the partial body casing 50 is further comprised of electronic communication means 55. The electronic communication means 55 operably connects the control unit 60 to the at least one sensor member 53 and any sensor members 23, 33 that are included in any hand casings 20 or foot casings 30 that comprise the apparatus 10 so that the control unit 60 is in electronic communication with such sensor members 53, 23, 33. Thus, for example, the electronic communication means 55 may be comprised of a system of metallic conducting members or optical fibers that are connected to the control unit 60 at one end and to the at least one sensor member 53 or casing connectors 26, 36 at the other end, so that the electronic communication means 55 may also acts as a portion of the electronic communication means 25 and 35 of the hand casing 20 and the foot casing 30, respectively, as described above and illustrated in connection with FIG. 2A and FIG. 3. In various embodiments, the electronic communication means 55 may generally have substantially the same type of structure, features, characteristics and operation as any of the embodiments of the electronic communications systems 25 or 35 that may be used in connection with the hand casing 20 or foot casing 30, as described above and illustrated in connection with FIG. 2A and FIG. 3, respectively. In the illustrated embodiment, the partial body casing 50 is also comprised of at least one sensor member 53, which is generally operably connected to the control unit 60 by the electronic communication means 55, so that the at least one sensor member 53 is in electronic communication with the control unit 60. In various embodiments, the at least one sensor member 53 may generally have substantially the same type of structure, features, characteristics and operation as any of the embodiments of the sensor members 23 or 33 that may be used in connection with the hand casing 20 or foot casing 30, as described above and illustrated in connection with FIG. 2A and FIG. 3, respectively. Further, as illustrated in FIG. 1A, in some embodiments the partial body casing 50 may also be comprised of a lumen system 80. In the illustrated embodiment, the lumen system 80 is generally comprised of at least one lumen tubing member 81, a filter system 82, and a flow control valve (not illustrated). The filter system 82 is positioned on a surface of the partial body casing 50, and is comprised of any filter system that may be used to remove hazardous substances from air or other gas, as appropriate. For example, the filter system 82 may be comprised of a micro-pore filter, an antimicrobial filter or a hydrophobic filter, or any combination of such filters. The flow control valve, which is operably positioned between the filter system 82 and the at least one lumen tubing member 81, is used to regulate the flow of air or other gas in the ambient environment into the partial body enclosure 51 so that the rate of introduction of such air or gas into the partial body enclosure 51 is not greater than the rate at which such air or gas can be removed by the reduced pressure supply source cooperating with the negative pressure distribution means 54. Thus, filtered ambient air or gas may be introduced into the partial body casing 50 in order to provide cooling for the user of the apparatus 10, while negative pressure may still be maintained within the volume of the partial body casing 50. In this and other embodiments of the apparatus 10, the lumen system 80 may generally have substantially the same type of structure, features, characteristics and operation as any of the embodiments of the lumen system 180 that may be used in connection with the hand casing 120, as described above and illustrated in connection with FIG. 2B. Further still, the control unit 60 comprising the partial body casing 50 may generally have substantially the same type of structure, features, characteristics and operation as any of the embodiments of the control unit 160 that may be used in connection with the hand casing 120, as described above and illustrated in connection with FIG. 2B.

In the embodiment illustrated in FIG. 1A, the apparatus 10 is also comprised of a head casing 40. It is to be noted that the head casing 40 may be used, and is preferably used, with the partial body casing 50. In other embodiments, however, the partial body casing 50 may be used without the head casing 40. The head casing 40 serves to protect the head of the user of the apparatus 10 from hazardous conditions present in the ambient environment. In the illustrated embodiment, the head casing 40 is generally comprised of a hood member 41, a faceplate member 42, and a filter system 43. The hood member 41 may generally be comprised of any of the materials that may be used to construct the partial body enclosure 51, the hand enclosure 21, or the foot enclosure 31, as described in more detail above and illustrated in connection with FIG. 1A, FIG. 2A, and FIG. 3, respectively. The faceplate member 41 is comprised of a transparent material that allows the user of the apparatus 10 to adequately see outside of the head casing 40. The material comprising the faceplate member 41 is also capable of maintaining its integrity when operating in the ambient environment. Examples of such material include polymethyl methacrylate (acrylic), as may be sold under the trade names Plexiglas and Lucite. The faceplate member 42 and the hood member 41 are connected in such a manner that there is a fluid-tight seal between them. Such fluid-tight seal may be accomplished using any suitable means, such as welding (including radio frequency and ultra sound welding), fusing (including heat sealing), adhesives, epoxies, ultra violet, agent bonding, or combinations of such means. The head filter system 43 is positioned on a surface of the head casing 40, and is used to provide the user of the apparatus 10 with a source of air that is free of the hazardous materials that may be present in the ambient environment. The head filter system 43 is comprised of any filter system that may be used to remove hazardous substances from air. For example, the head filter system 43 may be a micro-pore filter, an antimicrobial filter, or a hydrophobic filter or any combination of such filters. In other embodiments, the head casing 40 may be supplied with breathable gas (such as air or another gas mixture containing adequate oxygen) from an air supply source (not illustrated) cooperating with air supply source connection means to operably connect the air supply source to the head casing 40. This additional breathable source may be in addition to or in lieu of the head filter system 43. In such embodiments, the breathable gas may be contained in compressed form in one or more portable tanks carried by the user, or from another remote source, neither of which is illustrated. In either case, the breathable gas may be supplied to the head casing 40 by the air supply source connection means, which may be a hose mechanism (and possibly regulator mechanism) or any other similar means currently known in the relevant art or that may be developed in the art in the future, in each case connected to such source. It should be noted that in other embodiments, the head casing 40 may have a different structure, as long as it is capable of forming an adequate seal with the partial body casing 50. It is also to be noted that the head casing 40 may be comprised of a head liner (not illustrated), which may generally have substantially the same structure, features, characteristics, and operation as the partial body liner 52 described in more detail above and illustrated in connection with FIG. 1A, except that the head liner is adapted to cover the head (but not the face) of the user. Further, it is to be noted that the head casing 40 is not subject to negative pressure within its volume when in use. Generally, the partial body enclosure 51 of the partial body casing 50 is sealed to the portion of the user's neck approximately adjacent to the opening 51a of the partial body enclosure 51 by the extremity enclosure sealing means, which may be any of the extremity enclosure sealing means and methodologies that may be used in connection with any of the embodiments of the hand casing 20 or the foot casing 30, as described above and illustrated in connection with FIG. 2A and FIG. 3, respectively. After such seal is established, the interior surface of the portion 41a of the hood member 41 adjacent to the partial body enclosure 51 is sealed to the partial body enclosure 51 by the body/head sealing means, which may be any of the body/extremity enclosure sealing means and methodologies that may be used in connection with any of the embodiments of the apparatus 10, as described above and illustrated in connection with FIG. 1A.

An embodiment of a second version of the present invention is illustrated in FIG. 1B. In this embodiment, the apparatus 210 is generally comprised of a whole body casing 290, a head casing 240, a control unit 260, and body/head sealing means, which are described in more detail below. The whole body casing 290 generally has the same structure, features, characteristics, and operation as the combination of the partial body casing 50, the hand casings 20, and the foot casings 30, as described above and illustrated in FIG. 1A, except that the partial body casing 50, the hand casings 20, and the foot casings 30 are fabricated as a single piece in the apparatus 210. The head casing 240 may be removably attached to the whole body casing 290 in substantially the same manner (using the body/head sealing means) as the head casing 40 may be removably attached to the partial body casing 50 in the embodiments of the apparatus 10 described above and illustrated in connection with FIG. 1A. The operation of the apparatus 210 is substantially the same as the operation of the apparatus 10. It is to be noted that the whole body casing 290 is further comprised of negative pressure distribution means 294, which is connected to the control unit 260 by means of a manifold 294a. It is to be noted that the whole body casing 290 may be further comprised of a lumen system 280, which is connected to and may be controlled by the control unit 260 in substantially the same manner as the lumen system 180 is controlled by the control unit 160 in the apparatus 110, as described above and illustrated in connection with FIG. 2B.

Referring again to FIG. 1A, in operation the user of the apparatus 10 may place the partial body casing 50 on first, followed by placement the hand casings 20 and the foot casings 30 in any order. Alternatively, the hand casings 20 and foot casings 30 or may be placed first, followed by placement of the partial body casing 50. It is to be noted that such components may be placed in any appropriate order desired by the user of the appliance 10. After placement of the partial body casing 50, the hand casings 20, and the foot casings 30, such components are operably connected together and sealed to one another or to the body or both in the manner described in more detail herein. For example, the component comprising the casing connector 26 that is a part of the hand casing 20 is connected to the component of the casing connector 26 that is a part of the partial body casing 50, and the hand enclosure 21 is sealed to the partial body enclosure 51 by the body/extremity enclosure sealing means described in more detail herein. The head casing 40 is then preferably placed in position and operably connected to and sealed to the partial body casing 50 in the manner described in more detail herein.

1. An apparatus for providing protection to at least an extremital portion of a body against environments containing hazardous materials, the apparatus comprising:
(a) an extremity enclosure having an extremity enclosure opening, wherein the extremity enclosure is fluid-impermeable, is not adversely affected by the hazardous materials, and is of a size and shape adapted to be placed over and enclose the extremital portion of the body;
(b) extremity enclosure sealing means to seal the extremity enclosure opening, so that negative pressure may be maintained in the volume surrounding the extremital portion of the body within the extremity enclosure; and
(c) negative pressure supply means, wherein the negative pressure supply means operably connects a negative pressure supply source to the extremity enclosure, so that negative pressure may be supplied to the volume within the extremity enclosure by the negative pressure supply source.

2. The apparatus of claim 1, wherein the apparatus further comprises:
(a) at least one sensor member positioned within or on the extremity enclosure; and
(b) electronic communication means for operably connecting the at least one sensor member to a control unit.

3. The apparatus of claim 2, wherein the apparatus further comprises the control unit.

4. The apparatus of claim 1, wherein the apparatus further comprises the negative pressure supply source, which is further comprised of a portable vacuum pump.

5. The apparatus of claim 1, wherein a portion of the extremity enclosure is shaped approximately as a hand and wrist.

6. The apparatus of claim 1, wherein a portion of the extremity enclosure is shaped approximately as a foot and ankle.

7. The apparatus of claim 1, wherein the apparatus is further comprised of an extremity liner having a liner opening, wherein the extremity liner is of a size and shape adapted to be placed over and enclose the extremital portion of the body and is positioned between the extremital portion of the body and the extremity enclosure.

8. The apparatus of claim 7, wherein extremity enclosure sealing means is used to seal the portion of the extremity liner that is adjacent to the liner opening to the portion of the body adjacent to such portion of the extremity liner.

9. The apparatus of claim 7, wherein extremity enclosure sealing means is used to seal the portion of the extremity liner that is adjacent to the liner opening to the portion of the extremity enclosure that is adjacent to such portion of the extremity liner.

10. The apparatus of claim 1, wherein:
(a) the apparatus further comprises negative pressure distribution means for distributing negative pressure in the volume within the extremity enclosure; and
(b) the negative pressure distribution means are operably connected to the negative pressure supply means.

11. The apparatus of claim 1, wherein the apparatus further comprises a lumen system for providing fluids to and removing fluids from the volume within the extremity enclosure.

12. The apparatus of claim 1, wherein the extremity enclosure further comprises means to assist in putting on and taking off the extremity enclosure.

13. The apparatus of claim 1, wherein the negative pressure maintained in the volume within the extremity enclosure is in the range between 40 mm Hg and 150 mm Hg.

14. The apparatus of claim 1, further comprising:
(a) an environmental enclosure having a boundary wall, wherein the interior volume of the environmental enclosure is isolated from the surrounding environment so that the hazardous materials do not come into contact with the surrounding environment;
(b) a portal member, wherein the portal member is positioned within a portal in the boundary wall;
(c) portal sealing means to operably seal the portal member to the extremity enclosure wherein the volume within the extremity enclosure is not in fluid communication with the volume inside the environmental enclosure.

15.-22. (canceled)

23. The apparatus of claim 1 further comprising:
(a) a partial body enclosure, wherein the partial body enclosure is fluid-impermeable, is not adversely affected by the hazardous materials, is of a size and shape adapted to be placed over and enclose the torso and portions of the neck, arms and legs of the body that are not enclosed within the extremity enclosure, and has a body enclosure opening at each end of the neck, arm and leg portions of the partial body enclosure;
(b) a seal that operably seals each body enclosure opening, so that negative pressure may be maintained in the volume surrounding the portion of the body within the partial body enclosure; and
(c) negative pressure distribution means, wherein the negative pressure distribution means operably connect a negative pressure supply source to the partial body enclosure and distribute negative pressure in the volume within the partial body enclosure;
wherein the seal at the body enclosure opening adjacent to the at least one extremity enclosure and the extremity enclosure sealing means operably seal the extremity enclosure to the partial body enclosure so that negative pressure may be maintained in the volume surrounding the portion of the body within the partial body enclosure and the extremital portion of the body within the extremity enclosure.

24. The apparatus of claim 23, wherein the apparatus further comprises
(a) a least one body sensor member positioned within or on the partial body enclosure;
(b) a control unit that monitors or controls operating conditions of the apparatus; and
(c) electronic communication means for operably connecting the at least one body sensor member to the control unit.

25. (canceled)

26. The apparatus of claim 23, wherein the apparatus is further comprised of a partial body liner, wherein the partial body liner is of a size and shape adapted to be placed over and enclose the torso and a portion of the neck, arms and legs of the body, is positioned between the torso, neck, arms and legs of the body and the partial body enclosure, and has a liner opening at each end of the neck arm and leg portions of the partial body liner.

27. The apparatus of claim 23, wherein the apparatus further comprises a lumen system for providing fluids to and removing fluids from the volume within the partial body enclosure.

28. The apparatus of claim 23, wherein the partial body enclosure further comprises means to assist in putting on and taking off the partial body enclosure.

29.-31. (canceled)

32. The apparatus of claim 23, further comprising:
(a) a head casing, which further comprises a head enclosure having a head enclosure opening, wherein the head enclosure is fluid-impermeable, is not adversely affected by the hazardous materials, is of a size and shape adapted to be placed over and enclose the head and neck portions of the body that are not enclosed by the partial body enclosure, and is adapted to have the portion of the head enclosure surrounding the head enclosure opening positioned adjacent to the portion of the partial body enclosure that surrounds the opening at each end of the neck portion of the partial body enclosure; and
(b) the seal at the body enclosure opening adjacent to the head casing is further comprised of body/head enclosure sealing means, which operably seal the portion of the head enclosure that is positioned adjacent to the partial body enclosure to the partial body enclosure, so that the volume within the head enclosure is not in fluid communication with the ambient environment or the volume within the partial body enclosure.

33. The apparatus of claim 23, wherein the negative pressure maintained in the volume within the partial body enclosure is in the range between 40 mm Hg and 150 mm Hg.

34. The apparatus of claim 1, wherein the at least one extremital portion of the body comprises two hands and the extremity enclosure comprises two hand enclosures, each having a portion in the approximate shape of a hand and wrist, and further comprising:
(a) a partial body casing, which further comprises:
(i) a partial body enclosure, wherein the partial body enclosure is fluid-impermeable, is not adversely affected by the hazardous materials, is of a size and shape adapted to be placed over and enclose the torso and a portion of the neck, arms and legs of the body that are not enclosed within the extremity enclosure, and has a body enclosure opening at each end of the neck, arm and leg portions of the partial body enclosure;
(ii) neck portion sealing means to operably seal the portion of the partial body enclosure that is adjacent to the body enclosure opening at the end of the neck portion of the partial body enclosure, so that negative pressure may be maintained in the volume surrounding the portion of the body within the partial body enclosure; and
(iii) negative pressure distribution means, wherein the negative pressure distribution means operably connects a negative pressure supply source to the partial body enclosure and distribute negative pressure in the volume within the partial body enclosure;
(b) wherein each hand enclosure is adapted to have the portion surrounding the hand enclosure opening positioned adjacent to the portion of the partial body enclosure that surrounds the enclosure opening at the end of the arm portion of the partial body enclosure; and
(c) two foot casings, where each of the two foot casing further comprises:
(i) a foot enclosure having a portion in the approximate shape of a foot and ankle, wherein the foot enclosure has a foot enclosure opening, is fluid-impermeable, is not adversely affected by the hazardous materials, and is of a size and shape adapted to be placed over and enclose a foot, ankle and leg portion of the body that is not enclosed by the partial body enclosure, except that the foot enclosure is adapted to have the portion surrounding the foot enclosure opening positioned adjacent to the portion of the partial body enclosure that surrounds the enclosure opening at the end of the leg portion of the partial body enclosure; and
(ii) a foot enclosure negative pressure supply means to operably connect the negative pressure supply source to the foot enclosure, so that negative pressure may be supplied to the volume within the foot enclosure; and
(d) body/extremity enclosure sealing means to operably seal the adjacent portions of each of the two hand enclosures and each of the two foot enclosures to the partial body enclosure, so that negative pressure may be maintained in the volume within the partial body enclosure and the two hand enclosures and two foot enclosures.

35. The apparatus of claim 34, wherein the apparatus further comprises:
(a) a partial body liner, wherein the partial body liner is of a size and shape adapted to be placed over and enclose the torso and a portion of the neck, arms and legs of the body, is positioned between the torso, neck, arms and legs of the body and the partial body enclosure, and has a liner opening at each end of the neck arm and leg portions of the partial body liner; and
(b) extremity enclosure sealing means to operably seal the portions of the partial body that are adjacent to the liner openings at the neck, arm and leg portions of the partial body liner.

36. The apparatus of claim 34, wherein the apparatus further comprises:
(a) at least one hand liner having a hand liner opening, wherein:
(i) a portion of the at least one hand liner is approximately in the shape of a hand and wrist and is of a size and shape adapted to be placed over and enclose the hand, wrist and lower arm portion of the body; and
(ii) the at least one hand liner is positioned between the portion of the body enclosed by the at least hand liner and the hand enclosure; and
(b) extremity enclosure sealing means to operably seal the portion of the at least one hand liner that is adjacent to the hand liner opening to the adjacent portion of the body or the partial body liner or both.

37. The apparatus of claim 34, wherein the apparatus further comprises:
(a) at least one foot liner having a foot liner opening, wherein:
(i) a portion of the at least one foot liner is approximately in the shape of a foot and ankle and is of a size and shape adapted to be placed over and enclose the foot, ankle and lower leg portion of the body; and
(ii) the at least one foot liner is positioned between the portion of the body enclosed by the at least foot liner and the foot enclosure; and
(b) extremity enclosure sealing means to operably seal the portion of the at least one foot liner that is adjacent to the foot liner opening to the adjacent portion of the body or the partial body liner or both.

38.-39. (canceled)

40. The apparatus of claim 34, wherein the apparatus further comprises means to assist in putting on and taking off the partial body casing.

41. The apparatus of claim 34, wherein the apparatus further comprises:
(a) at least one head casing, which further comprises a head enclosure having a head enclosure opening, wherein the head enclosure is fluid-impermeable, is not adversely affected by the hazardous materials, is of a size and shape adapted to be placed over and enclose the head and neck portions of the body that are not enclosed by the partial body enclosure, and is adapted to have the portion of the head enclosure surrounding the head enclosure opening positioned adjacent to the portion of the partial body enclosure that surrounds the enclosure opening at each end of the neck portion of the partial body enclosure; and
(b) body/head enclosure sealing means to seal the portion of the head enclosure that is positioned adjacent to the partial body enclosure to the partial body enclosure, so that the volume within the head enclosure is not in fluid communication with the ambient environment or the volume within the partial body enclosure.

42. The apparatus of claim 41, wherein the apparatus further comprises an air supply source and air supply source connection means to operably connect the air supply source to the head enclosure, so that a supply of breathable air may be supplied to the volume within the head enclosure by the air supply source.

43. The apparatus of claim 34, wherein the negative pressure maintained in the volume within the extremity enclosure is in the range between 40 mm Hg and 150 mm Hg.

44.-52. (canceled)
